(19) United States
(12) Patent Application Publication
(10) Pub. No.: US 2006/0227695 A1
(43) Pub. Date: Oct. 12, 2006

(54) Recording media

(75) Inventor: Katsurou Nagaoka, Minami-Ashigata-shi (JP)

Correspondence Address: BUCHANAN, INGERSOLL & ROONEY PC, POST OFFICE BOX 1404, ALEXANDRIA, VA, 22313-1404, US

(73) Assignee: Fuji Photo Film Co., Ltd., Kanagawa (JP)

(21) Appl. No.: 10/568,662

(22) PCT Filed: Sep. 17, 2004
(86) PCT No.: PCT/JP04/14012

§ 371 Date: Feb. 17, 2006

(30) Foreign Application Priority Data
Sep. 17, 2003 (JP) 2003-324183
Nov. 19, 2003 (JP) 2003-389263

(51) Int. Cl. G11B 7/24

(52) U.S. Cl. 369/275.1

(57) ABSTRACT

To provide a recording media capable of reproducing an information signal by an optical means, which effectively prevents formation of flaws on the light-incident surface thereof and has an excellent storage stability, the recording media includes a support; a recording layer capable of recording the information signal; and a light-transmitting layer capable of transmitting a light in this order, wherein the light-transmitting layer includes a light-transmitting film having a moisture expansion coefficient of 8 ppm/% RH to 62 ppm/% RH; and the light-transmitting layer has a surface having a pencil hardness of 2 H or more.

### TECHNICAL FIELD

The present invention relates to a recording media capable of recording and reproducing an information signal by an optical or magnetic means and, more particularly, to a recording media capable of reproducing an information signal by an optical means.

### BACKGROUND ART

A recording media called CD-R has widely been known as an additionally recordable optical recording media which permits recording only once by a laser light. CD-R has the advantage that information recorded thereon can be reproduced by means of a commercially available CD player. Recently, a demand for CD-R has increased with the spread of personal computers. Also, as a recording media which permits a larger volume of recording than CD-R, an additionally recordable digital versatile disc (DVD-R) adapted for recording digital high-vision images has also been put into practice.

As such additionally recordable optical recording media, there have been known, for example, those media which comprises a disc-shaped support having provided thereon in order an light-reflecting layer comprising Au or the like, a recording layer comprising an organic compound and a light-transmitting layer for protecting the recording layer (including an adhesive layer for adhering the light-transmitting layer to the recording layer, which is also called a cover layer). They permit recording and reproduction of information by irradiating them with a laser light from the light-transmitting layer side. Recording of information on the additionally recordable optical recording media is conducted in such manner that laser light-irradiated areas of the recording layer absorb the light and generate heat to undergo deformation (for example, generation of pits). On the other hand, reproduction of information is usually conducted by irradiating the additionally recordable optical recording media with a laser light of the same wavelength as that of the laser light used for recording and detecting difference in reflectivity between the heat-deformed areas (recorded areas) and non-deformed areas (non-recorded areas) of the recording layer.

Recently, networks such as Internet and high-vision TV have been rapidly spread. Also, televising of HDTV (High Definition Television) has been initiated. Under such circumstances, a large volume optical recording media which can record image information inexpensively with ease has been required. At present, the above-mentioned DVD-R is fully performing its function as a large volume recording media. However, a demand for a larger volume recording with a higher recording density is increasing more and more, and hence development of a recording media which can meet such demand is necessary. Therefore, as an optical recording media, a larger volume recording media which can record information with a higher density using a short wavelength light is under development. In particular, a demand for development of an additionally recordable optical recording media which permit recording of information only once is strong because its use as a medium for storing or back-up of a large volume of information for a long period of time is increasing.

Usually, recording of information with a higher density on an optical recording media can be attained by making a beam spot smaller through employment of a shorter wavelength laser light for recording and reproducing information and increasing NA (Numerical Aperture) of an objective lens used for a pickup. Recently, development has been rapidly advanced to a level of using a red semiconductor laser light of 680 nm, 650 nm and 635 nm in wavelength and, further, a bluish violet semiconductor laser light of 400 nm to 500 nm which enables recording with an ultra-high density (hereinafter referred to as “bluish violet laser light”), and development of an optical recording media adapted therefor is being conducted. In particular, since the bluish violet laser has been put on the market, development of an optical recording system which utilizes the bluish violet laser and the high NA pick-up has been made, and a rewritable optical recording media having a recording layer which can cause phase change and an optical recording system has been published as a DVR system (see, for example, Hikari Memory Kokusai Shinpozium (ISOM2000) Yokoshu, p. 210-211). A certain successful result was obtained as to the subject of recording information on a rewritable optical recording media with a higher density.

With an optical recording media for use in the above-mentioned optical recording system utilizing the bluish violet laser and the high NA pick-up, it is preferred to reduce the distance from the laser light-incident surface of the recording media to the recording layer (that is, to reduce the thickness of light-transmitting layer). Therefore, the thickness of light-transmitting layer is specified to be 100 μm. Since such optical recording media utilizes the high NA pick-up, the distance between the pick-up and the light-transmitting layer is so small that there has been involved a problem that the pick-up can contact with the light-transmitting layer due to fluctuation of the surface of the optical recording media, leading to formation of marring on the light-transmitting layer.

In order to solve this problem, it has been already proposed to provide a marring-preventing layer or a hard coat layer on the light-transmitting layer using a spin coating method or a vacuum deposition method for preventing formation of flaws on the light-transmitting layer (see, for example, Japanese Patent No. 3,112,467 or JP-A-2000-67468). However, the marring-preventing layer or the hard coat layer is provided on the light-transmitting layer one by one according to the above-mentioned method, and hence there has been involved a problem of a low productivity. Also, in the case of providing the marring-preventing layer or the hard coat layer, thickness of the more peripheral portion of the layer tends to become larger due to centrifugal force, resulting in an insufficient accuracy with thickness.

On the other hand, there has been a method of constituting the light-transmitting layer by using a transparent, thin film such as a cellulose acylate film and adhering the film to the recording layer with a adhesive or a pressure sensitive adhesive (see, for example, JP-A-2002-170280 or JP-A-2002-197723). The thickness of the light-transmitting layer is usually about 100 μm including an adhesive layer or a pressure sensitive adhesive layer formed by curing of the adhesive or the pressure sensitive adhesive, and is optimized depending upon the wavelength of irradiated laser light and NA. Although the recording media constituted by such method has an excellent productivity, a commercially available cellulose acylate film contains a phosphate-based and/or phthalate-based plasticizer in a content of from 15 to 20% by weight, and undergoes change in dimension under the condition of high temperature and high humidity due to reduction of the amount of plasticizer as a result of migration or evaporation of the plasticizer, leading to the problems of curling and deterioration of adhesion force. Thus, the conventional recording media involves the problem that recording of information becomes impossible or that reading of the recorded information becomes impossible.

Also, JP-A-2003-157579 describes an optical recording media using a film comprising a cyclic polyolefin as a light-transmitting layer, but this medium does not have sufficient anti-scratching properties.

### DISCLOSURE OF THE INVENTION

An object of the invention is to provide an recording media capable of reproducing an information signal by an optical means, which is excellent in storage stability and which permits good recording and reproducing information without dimensional change of a light-transmitting layer and generation of curling particularly under the conditions of high temperature and high humidity. Another object of the invention is to provide a recording media which effectively prevents formation of flaws on the light-incident surface thereof and has an excellent storage stability.

As a result of intensive investigations, the inventors have found that the above-mentioned problems can be solved by the following constitution.

(1) A recording media capable of reproducing an information signal by an optical means, which comprises: a support; a recording layer capable of recording the information signal; and a light-transmitting layer capable of transmitting a light in this order,

wherein the light-transmitting layer comprises a light-transmitting film having a moisture expansion coefficient of 8 ppm/% RH to 62 ppm/% RH; and the light-transmitting layer has a surface having a pencil hardness of 2 H or more.

(2) The recording media as described in claim 1, wherein the light-transmitting layer comprises a hard coat layer on the light-transmitting film,

wherein the hard coat layer comprises a cured film formed from a curable composition comprising: a first curable resin having a molecule, the molecule having two or more ethylenically unsaturated groups; and a second curable resin having a ring-opening polymerizable group.

(3) The recording media as described in (2), wherein the light-transmitting film is a cyclic polyolefin film.

(4) The recording media as described in (2), wherein the light-transmitting film is a polycarbonate film.

(5) A recording media capable of reproducing a information signal by an optical means, which comprises: a support; a recording layer capable of recording the information signal; and a light-transmitting layer capable of transmitting a light in this order,

wherein the light-transmitting layer comprises a light-transmitting film comprising a cellulose acylate film, the cellulose acylate film comprising at least one deterioration-preventing agent selected from the group consisting of (A) a peroxide-decomposing agent, (B) a radical chain inhibitor, (C) a metal-inactivating agent and (D) an acid-captivating agent.

(6) A recording media capable of reproducing a information signal by an optical means, which comprises: a support; a recording layer capable of recording the information signal; and a light-transmitting layer capable of transmitting a light in this order,

wherein the light-transmitting layer comprises a light-transmitting film comprising a cellulose acylate film, the cellulose acylate film having an organic chlorine-containing solvent of 10 ppm or less.

(7) A recording media capable of reproducing a information signal by an optical means, which comprises: a support; a recording layer capable of recording the information signal; and a light-transmitting layer capable of transmitting a light in this order,

wherein the light-transmitting layer comprises a light-transmitting film comprising a cellulose acylate film, the cellulose acylate film comprising a polyhydric alcohol ester of an aliphatic polyhydric alcohol and a monocarboxylic acid.

(8) The recording media as described in (7), wherein the monocarboxylic acid has an aromatic ring or a cycloalkyl ring.

(9) The recording media as described in (7) or (8), wherein the aliphatic polyhydric alcohol is one of 2- to 20-valent alcohols.

(10) The recording media as described in any one of (5) to (9), wherein the light-transmitting film having a moisture expansion coefficient of 8 ppm/% RH to 62 ppm/% RH.

(11) The recording media as described in any one of (5) to (10), wherein the light-transmitting layer has a hard coat layer on the light-transmitting film; and the hard coat layer comprises a cured film formed from a curable composition, the curable composition comprising a curable resin capable of being cured upon an active energy ray.

(12) The recording media as described in (11), wherein the curable composition comprises a first curable resin having a molecule, the molecule having two or more ethylenically unsaturated groups; and a second curable resin having a ring-opening polymerizable group.

(13) The recording as described in any one of (1) to (12), wherein the light-transmitting layer has a thickness of 50 μm to 300 μm.

The invention can provide a recording media which has an excellent storage stability and does not suffer deterioration of flatness even under high temperature and high humidity and which has good recording and reproducing performance. Also, the invention can provide a recording media whose surface is prevented from being flawed or stained and which has an excellent storage stability. The recording media of the invention is particularly effective for an optical recording system utilizing a bluish violet laser and a high NA pick-up.

### DETAILED DESCRIPTION OF THE INVENTION

The recording media of the invention is described in more detail below. Additionally, in this specification, the term “(numerical value 1) to (numerical value 2)” means “from (numerical value 1) to (numerical value 2) inclusive”.

The recording media (information recording media or medium) of the invention is an recording media capable of reproducing an information signal by an optical means. The recording media of the invention fundamentally comprises a support, a recording layer which can record an information signal and which is formed on the support, and a light-transmitting layer which is formed on the recording layer and which can transmit a light. The constituent layers may be mutually exchanged or combined within a range of not spoiling the invention. At least one layer is required to exist as each constituent layer, and each constituent layer may comprise a plurality of the same layers, or one constituent layer may comprise a plurality of layers different from each other in composition or properties. Specifically, it is possible to provide two recording layers and two light-transmitting layers on one side of a support such as a support/a recording layer/a light-transmitting layer/a recording layer/a light-transmitting layer, or to provide a recording layer and a light-transmitting layer on both sides of a support such as a light-transmitting layer/a recording layer/a support/a recording layer/a light-transmitting layer. In addition to the above-mentioned constitutions, a known antistatic layer, a known lubricating layer, a known protective layer and a known reflective layer may be provided. Also, the opposite side of the support to the side on which the recording layer is provided may be subjected to label printing.

The recording media of the invention may be retained within a cartridge. The medium is not limited as to its size and, with a disc-shaped recording media, the diameter thereof may be selected in a range of from, for example, 30 to 300 mm, and may be 32, 51, 65, 80, 120, 130, 200 or 300 mm.

In the recording media of the invention, the support is a base which functions to mechanically keep a recording layer and a light-transmitting layer to be described hereinafter.

Materials for constituting the support may be any of synthetic resins, ceramics and metals. Typical examples of the synthetic resin to be preferably used include various thermoplastic resins or thermosetting resins such as polycarbonate, polymethyl methacrylate, polystyrene, polycarbonate/polystyrene copolymer, polyvinyl chloride, alicyclic polyolelfin and polymethylpentene and various radiation-curable resins (including UV ray-curable resins and visible light-durable resins). Additionally, these may be synthetic resins containing blended therein metal powder or ceramic powder. Typical examples of the ceramics to be used include soda lime glass, soda aluminosilicate glass, borosilicate glass and quartz glass. Examples of the metals to be used include aluminum, copper and iron.

Of these, polycarbonate and amorphous polyolefin are preferred in view of dimensional stability and price, with polycarbonate being most preferred.

The thickness of the support is preferably 0.3 to 3 mm, desirably 0.6 to 2 mm, most preferably within a range of 1.1 mm±0.3 mm.

Pregrooves for tracking or for expressing information such as an address signal are formed on the surface of the support. Such pregrooves are preferably formed directly on the support upon injection molding or extrusion molding of the resin material such as polycarbonate.

Also, formation of pregroove may be conducted by providing a pregroove layer. As materials for the pregroove layer, a mixture of at least one monomer (or oligomer) selected from among acrylic acid monoester, diester, trimester, tetraester, pentaester and hexaester of polyol and a photopolymerization initiator may be used. Formation of the pregroove layer is obtained, for example, by coating a solution of the above-mentioned mixture of the acrylate and the polymerization initiator on an accurately formed mother mold (stamper) and, after placing thereon a support, irradiating the assembly through the support or the mother mold to cure the coated layer for fixing the support and the coated layer, then stripping off the support from the mother mold. The thickness of the pregroove layer is generally within a range of from 0.01 to 100 μm, preferably from 0.05 to 50 μm.

In the invention, track pitch of the pregrooves on the support is in a range of preferably from 200 to 400 nm, more preferably from 250 to 350 nm.

Also, the depth of pregroove is in a range of preferably from 10 to 150 nm, more preferably from 20 to 100 nm, still more preferably from 30 to 80 nm. The half-value width of the pregroove depth is in a range of preferably from 50 to 250 nm, more preferably from 100 to 200 nm.

In the case of providing a light-reflecting layer to be described hereinafter on the recording media of the invention, it is preferred to form an undercoat layer on the side of a support on which the light-reflecting layer is to be provided, for the purpose of improving flatness and adhesion force.

Examples of the materials for the undercoat layer include high molecular materials such as polymethyl methacrylate, acrylic acid/methacrylic acid copolymer, styrene/maleic anhydride copolymer, polyvinyl alcohol, N-methylolacrylamide, styrene/vinyltoluene copolymer, chlorosulfonated polyethylene, nitrocellulose, polyvinyl chloride, chlorinated polyolefin, polyester, polyimide, vinyl acetate/vinyl chloride copolymer, ethylene/vinyl acetate copolymer, polyethylene, polypropylene and polycarbonate; and surface-improving agents such as silane coupling agents.

The undercoat layer can be formed by dissolving or dispersing the above-mentioned materials in a suitable solvent to preparing a coating solution, and coating the resulting coating solution on the surface of a support according to a coating method such as spin coating method, a dip coating method or an extrusion coating method. The thickness of the undercoat layer is in a range of preferably from 0.005 to 20 μm, more preferably from 0.01 to 10 μm.

The light-reflecting layer can arbitrarily be prepared between the support and the recording layer for the purpose of improving reflectivity upon reproduction of information. The light-reflecting layer can be formed on the support by vacuum deposition, sputtering or ion plating of a light-reflecting substance having a high reflectivity for a laser light. The thickness of the light-reflecting layer is in a range of generally from 10 to 300 nm, preferably from 50 to 200 nm. Additionally, the reflectivity of the light-reflecting layer is preferably 70% or more.

Examples of the light-reflecting substance having a high reflectivity include metals or semimetals such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn and Bi, and stainless steel. These light-reflecting substances may be used alone or in combination of two or more thereof. They may also be used as alloy. Of these, Cr, Ni, Pt, Cu, Ag, Au, Al and stainless steel are preferred. Au, Ag, Al and alloys thereof are particularly preferred, with Au, Ag and alloys thereof being most preferred.

In the recording media of the invention, the recording layer is a layer which has the function of recording or rewriting information by permitting to record an information signal on the layer through an optical or magnetic means and which can reproduce an information signal from the layer through an optical reproducing means (e.g., laser light). In the case where the recording media is a read-only type recording media, materials which a high reflectivity are used for the recording layer and, in the case where the recording media is a rewritable recording media, materials for the recording layer are selected from materials for dye recording, materials for phase change recording and materials for optomagnetic recording depending upon the recording or reproducing principle. The thickness of the recording layer is preferably 2 to 300 nm, particularly preferably 5 to 200 nm.

Examples of the light-reflecting material to be used for the recording layer include gold and silver.

Specific examples of the material to be used for dye recording include cyanine dyes, phthalocyanine dyes, naphthalocyanine dyes, azo dyes, naphthoquinone dyes, fulgide dyes, polymethine dyes and acridine dyes.

Examples of the material to be used for phase change recording include alloys of indium, antimony, tellurium, selenium, germanium, bismuth, vanadium, gallium, platinum, gold, silver, copper, tin and arsenic (alloys including oxides, nitrides, carbides, sulfides and fluorides). In particular, it is preferred to use GeSbTe, AgInSbTe and CuAlTeSb. It is also possible to use as a recording layer a laminate film of indium alloy and tellurium alloy.

Examples of the material to be used for optomagnetic recording include alloys of terbium, cobalt, iron, gadolinium, chromium, neodymium, dysprosium, bismuth, palladium, samarium, holmium, praseodymium, manganese, titanium, palladium, erbium, ytterbium, lutetium and tin (alloys including oxides, nitrides, carbides, sulfides and fluorides). In particular, it is preferred to constitute the recording layer by an alloy of a transition metal and a rare earth element typically represented by TbFeCo, GdFeCo or DyFeCo. Further, the recording layer may be formed by using a layered film wherein cobalt film alternates with platinum film.

Additionally, an ancillary film such as an alloy of silicon, tantalum, zinc, magnesium, calcium, aluminum, chromium or zirconium (alloy including oxide, nitride and carbide) or a highly reflective film (e.g., aluminum, gold or silver) may be superposed on the recording layer in combination.

The recording layer using the recording material for dye recording contains preferably a dye having an absorption maximum in the wavelength region of a laser light to be used for recording, particularly preferably a dye having an absorption maximum in the wavelength of 500 nm or less so as to record and reproduce information using a laser light of 500 nm or less in wavelength. Examples of the dyes to be used include cyanine dyes, oxonol dyes, metal complex-based dyes, azo dyes and phthalocyanine dyes. Specific preferred examples thereof include dyes described in JP-A-4-74690, JP-A-8-127174, JP-A-11-53758, JP-A-11-334204, JP-A-11-334205, JP-A-11-334206, JP-A-11-334207, JP-A-2000-43423, JP-A-2000-108513 and JP-A-2000-158818 and dyes such as triazole dyes, triazine dyes, cyanine dyes, merocyanine dyes, aminobutadiene dyes, phthalocyanine dyes, cinnamic acid dyes, viologen dyes, azo dyes, oxonol dyes, benzoxazole dyes and benzotriazole dyes. Of these, cyanine dyes aminobutadiene dyes, benzotriazole dyes and phthalocyanine dyes are preferred.

In the case of using a recording material for dye recording, the recording layer can be formed by dissolving the aforementioned dye and, as needed, a binder in an appropriate binder to prepare a coating solution, coating the resulting coating solution on the pregrooved surface of the support or on the surface of the light-reflecting layer to form a coating film, and drying the film. Further, to the coating solution may be added, as needed, various additives such as an antioxidant, a UV absorbent, a plasticizer and a lubricant depending upon the end-use.

Also, examples of methods for dissolving the dye or the binder to be applied include an ultrasonic wave treatment, a homogenizer treatment, a disper treatment, a sand mill treatment and a stirrer treatment.

Examples of the solvent for the coating solution include esters such as butyl acetate and cellosolve acetate; ketones such as methyl ethyl ketone, cyclohexanone and methyl isobutyl ketone; chlorinated hydrocarbons such as dichloromethane, 1,2-dichloroethane and chloroform; amides such as dimethylformamide; hydrocarbons such as cyclohexane; ethers such as tetrahydrofuran, ethyl ether and dioxane; alcohols such as ethanol, n-propanol, isopropanol, n-butanol and diacetonealcohol; fluorine-containing solvents such as 2,2,3,3-tetrafluoropropanol; and glycol ethers such as ethylene glycol monomethyl ether, ethylene glycol monoethyl ether and propylene glycol monomethyl ether. These solvents may be used independently or in a proper combination of two or more thereof in consideration of the solubility of the dye or the binder to be used.

Examples of the binder include natural organic high molecular materials such as gelatin, cellulose derivative, dextran, rosin and rubber; and synthetic organic high polymers such as polyurethane, hydrocarbon-based resins (such as polyethylene, polypropylene, polystyrene and polyisobutyrene), vinyl-based resins (such as polyvinyl chloride, polyvinylidene chloride and polyvinyl chloride/polyvinyl acetate copolymer), acrylic resins (such as polymethyl acrylate and polymethyl methacrylate), polyvinyl alcohol, chlorinated polyethylene, and initial condensates of thermosetting resins (such as epoxy resin, butyral resin, rubber derivative and phenol/formaldehyde). In the case of using the binder in combination with the dye as the material for the recording layer, the amount of the binder to be used is in a range of preferably from 0.01 to 50-fold amount (by weight) based on the dye, more preferably from 0.1 to 5-fold amount. It is also possible to improve storage stability of the recording layer by incorporating the binder in the recording layer.

The concentration of the dye in the thus prepared coating solution is in a range of generally from 0.01 to 10% by weight, preferably from 0.1 to 5% by weight.

Examples of the coating method include a spray coating method, a spin coating method, a dip coating method, a roll coating method, a blade coating method, a doctor roll coating method and a screen printing method. The coating temperature may be 23 to 50° C. with no particular problems, and is preferably 24 to 40° C., more preferably 25 to 37° C.

Various antifading agents may be incorporated in the recording layer in order to improve light fastness of the recording layer.

As the anti-fading agent, singlet oxygen quenchers are generally used. As the singlet oxygen quencher, those which are known and described in published documents such as patent specifications may be utilized. Specific examples thereof include those which are described in JP-A-58-175693, JP-A-59-81194, JP-A-60-18387, JP-A-60-19586, JP-A-60-19587, JP-A-60-35054, JP-A-60-36190, JP-A-60-36191, JP-A-60-44554, JP-A-60-44555, JP-A-60-44389, JP-A-60-44390, JP-A-60-54892, JP-A-60-47069, JP-A-63-209995, JP-A-4-25492, JP-B-1-38680 and JP-B-6-26028, German Patent No. 350399, and Nihon Kagakukaishi, 1992, No. 10, p. 1141.

The content of the anti-fading agent such as the singlet oxygen quencher is in a range of usually 0.1 to 50% by weight, preferably 0.5 to 45% by weight, more preferably 3 to 40% by weight, particularly preferably 5 to 25% by weight.

An interlayer (a barrier layer) may be formed on the surface of the recording layer for the purpose of enhancing adhesion properties to the light-transmitting layer and preservability of the dye. The barrier layer is a layer comprising a material such as oxide, nitride, carbide or sulfide comprising one or more atoms of Zn, Si, Ti, Te, Sm, Mo and Ge, and may be hybridized like ZnS—SiO₂. The barrier layer can be formed by sputtering, vacuum deposition ion plating, or the like, and the thickness thereof is adjusted to be preferably 1 to 100 nm.

In the image recording media of the invention, the light-transmitting layer physically functions to guide focused reproduced light to the recording layer and, at the same time, chemically and mechanically functions to protect the recording layer. The light-transmitting layer of the invention is preferably constituted by a film having a thickness smaller than that of the support.

Additionally, in the invention, the term “light-transmitting” means actually transparent (70% or more, desirably 80% or more, in transmittance) to the light of wavelength used for the optical means for use in reproducing records (e.g., 600 to 800 nm).

The light-transmitting layer of the invention comprises a light-transmitting film having a moisture expansion coefficient of 8 ppm/% RH to 62 ppm/% RH. In case where the moisture expansion coefficient is outside the above-mentioned range, the recording media can be deformed depending upon environmental change. This may be attributed to that a difference in moisture expansion n coefficient between the light-transmitting film and the substrate becomes large. In case where the recording media is deformed, the recording layer is so adversely affected that adaptability thereof for reproducing records is deteriorated and that stability of reproducing records becomes worse. The moisture expansion coefficient is more preferably 8 ppm/% RH to 50 ppm/% RH, still more preferably 8 ppm/% RH to 40 ppm/% RH.

In the invention, the term “moisture expansion coefficient” means dimensional change of a film when the environment is changed from 25° C. and 20% RH to 25° C. and 80% RH. That is, the moisture expansion coefficient (unit: ppm/% RH) is represented as [[(L₈₀−L₂₀)/L₂₀]/(80−20)]×10⁶ (wherein L₂₀ represents the size of the film at 25° C. and 20% RH, and L₈₀ represents the size of the film at 25° C. and 80% RH. For example, the moisture expansion coefficient of a film can be determined by cutting it into a rectangle of 5 cm in width and 28 cm in length, and measuring its length under the environment of 25° C. and 20% RH and under the environment of 25° C. and 80% RH.

The moisture expansion coefficient of the light-transmitting film can be adjusted by properly selecting the kinds and the amounts of film materials and additives. Specifically, it is preferred to use a cellulose acylate film containing a specific deterioration-preventing agent, a cellulose acylate film containing a depressed amount of chlorine-containing organic solvent, a cellulose acylate film containing a specific polyhydric alcohol ester, or a cyclic polyolefin film or a polycarbonate film as the light-transmitting film.

As the light-transmitting film to be used for the light-transmitting layer of the invention, those which are produced without stretching are preferred. When produced by applying stretching technique, film can show optical anisotropy in the stretched direction. Such film is not preferred as the light-transmitting layer of the recording media of the invention. Also, stretching can generate anisotropy of thermal expansion, and is not preferred in view of storage stability for a long period, either.

The light-transmitting film to be used for the light-transmitting layer of the invention is preferably a film comprising a cellulose derivative (particularly, cellulose acylate), cyclic polyolefin or polycarbonate.

Cellulose has a fundamental molecular structure of six-membered ring, and has three hydroxyl groups (OH) within this fundamental unit. Cellulose acylate can be synthesized by esterifying the hydroxyl groups using glacial acetic acid, propionic acid, butyric acid, acetic acid anhydride or propionic acid anhydride. Part or whole of the three hydroxyl groups can be esterified depending upon synthesizing condition. Of the esters, cellulose acylates wherein two or more hydroxyl groups are esterified can be formed into a thin sheet by a casting method or a melt extrusion method, and the synthesized cellulose acetates are characterized in that they are transparent materials of about 1.5 in refractive index, that they have a small intrinsic birefringence, and that they have a small dependence upon angle of light incidence. The cellulose acylate film obtained by applying tension to the cellulose acylate is a film is tough, and yet maintains the intrinsic birefringence of the material with showing a depressed difference between the birefringence in the longitudinal direction and the birefringence in the transverse direction. Thus, the film is appropriate as a light-transmitting film of the invention.

The cellulose acylate is preferably adjusted to be actually transparent (70% or more, preferably 80% or more, in transmittance) for the light of 350 to 450 nm in λ by selecting conditions for synthesizing the cellulose derivative. Because, cellulose acylate can be yellowed or whitened depending upon the conditions for synthesizing the cellulose derivative, and an recording media constituted by using such yellowed or whitened material can lead to deterioration of output of reproduced signal due to reduction in reflectivity.

The cellulose acylate filweightuch has the defect that it has a low tear strength and a low folding endurance and that, particularly under the condition of low humidity, it becomes seriously fragile and easy to tear. It has conventionally been conducted to add a low molecular plasticizer for the purpose of imparting flexibility. Examples of such plasticizer include phosphate-based plasticizers such as triphenyl phosphate, tricresylphosphate, triethyl phosphate and diphenylbiphenyl phosphate, phthalate-basede plasticizers such as dimethyl phthalate, diethyl phthalate and dimethoxyethyl phthalate, glycollate-based plasticizers such as ethyl phthalyl ethyl glycol. As other plasticizers, toluenesufonamide-based plasticizers and triacetin (glycerin triacetate) have been used.

However, the above-mentioned plasticizers are low molecular substances and have a boiling point of not exceeding 300° C. at the highest. On the other hand, the cellulose acylates are known as polymers having a poor compatibility with other substances, and even plasticizers having some compatibility have the serious defect that they have only a low boiling point as described above. Thus, serious migration of the plasticizers takes place upon forming the film, resulting in uneven distribution of the plasticizer in the depth direction of the film. It is known that the unevenness can cause curling of the film or that, since the plasticizer oozes onto the surface of the film, subsequent processing of the film involves troubles. Therefore, in order to remove the defects, it has been tried to mix a high molecular plasticizer, for example, polyester ether, polyester-urethane or polyester, or a combination of a high molecular plasticizer and a low molecular plasticizer, with cellulose acylate (for example, JP-B-47-760, JP-B-43-16305, JP-B-44-32672 and JP-A-2-292342), and the intended objects have been mostly attained. It has been found, however, that use of such support has the defects that, in comparison with supports containing only low molecular plasticizers (e.g., triphenyl phosphate), it shows seriously deteriorated stability when stored for a long period of time and is liable to cause coloration and breakage of the molecular chain.

In the invention, in order to obtain long-time storage stability, it is preferred to incorporate in the cellulose acylate film, at least one deterioration-preventing agent from among:
(A) peroxide-decomposing agents;
(B) radical chain-inhibiting agents;
(C) metal-inactivating agents; and
(D) acid-captivating agents.

Or, in order to obtain longtime storage stability, it is also preferred to adjust the content of an organic chlorine-containing solvent contained in the cellulose acylate film to a level of as low as 10 ppm or less, or to incorporate in the cellulose acylate film a polyhydric alcohol ester of an aliphatic polyhydric alcohol and one or more monocarboxylic acids.

The deterioration-preventing agents to be used in the invention are described below. In the invention, compounds represented by the following formulae (A-I), (A-II) and (A-III) are preferred as the peroxide-decomposing agents (A); compounds represented by the following formula (B-1) are preferred as the radical chain-inhibiting agents (B); compounds represented by the following formulae (C-I), (C-II) and (C-III) are preferred as the metal-inactivating agents (C); and compounds represented by the following formulae (D-I), (D-II), (D-III), (D-IV), (D-V), (D-VI), (D-VII) and (D-VIII) are preferred as the acid-captivating agents (D).

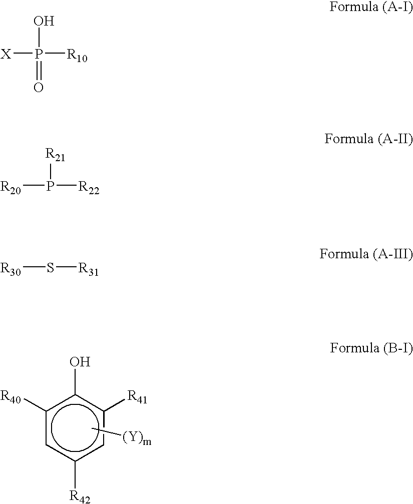

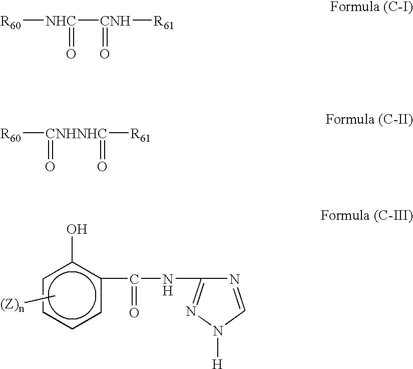

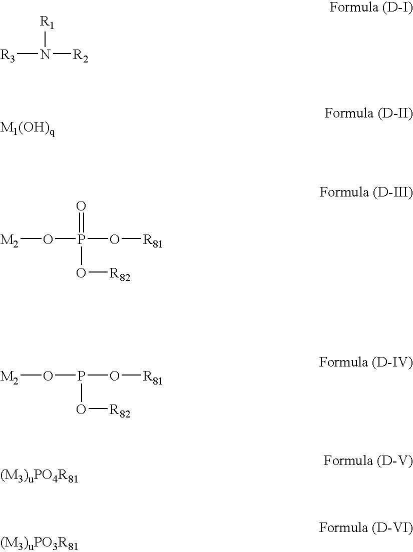

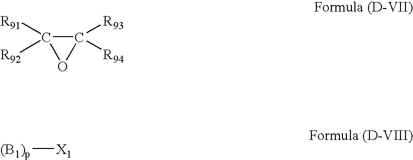

In the formulae (A-I) to (D-VII), X represents a hydrogen atom, an alkali metal or an alkaline earth metal. R₁₀ represents an alkyl group, an alkenyl group or an aryl group. R₂₀, R₂₁ and R₂₂, which may be the same or different, each represents an alkyl group, an alkenyl group, an aryl group, an alkoxy group, an alkenoxy group, an aryloxy group, an alkylthio group, an alkenylthio group or an arylthio group. R₃₀ and R₃₁, which may be the same or different, each represents an alkyl group, an alkenyl group or an aryl group. R₄₀ represents an alkyl group. R₄₁, R₄₂ and Y, which may be the same or different, each represents a hydrogen atom, an alkyl group, an alkenyl group, an aryl group, a hetero ring group, an alkoxy group, an alkenoxy group, an aryloxy group, a hetero ring oxy group, an alkylthio group, an alkenylthio group, an arylthio group, a hydroxyl group, an amino group which may have a substituent, a carbamoyl group, a sulfamoyl group, an alkoxycarbonyl group, an aryloxycarbonyl group, a halogen atom, a nitro group, a cyano group, an acyl group or an acyloxy group. m represents an integer of 0 to 2. R₆₀ and R₆₁, which may be the same or different, each represents an alkyl group, an alkenyl group, an aryl group or a hetero ring group. Z represents the group defined for Y, and n represents an integer of 0 to 4. When m represents 2, a plurality of Y's may be the same as or different from each other and, when n represents an integer of 2 to 4, a plurality of Z's may be the same as or different from each other. R₂₀ and R₂₁, or R₃₀ and R₃₁, may be connected to each other to form a 5- to 7-membered ring.

Also, R₁, R₂ and R₃, which may be the same or different, each represents a hydrogen atom, an aliphatic group, an aromatic group, a hetero ring group or an amino group. At least two of R₁, R₂ and R₃ may be connected to each other to form a 5- to 8-membered ring. Also, R₁ and R₂ may cooperate to form an unsaturated group, with the unsaturated group being connected to R₃ to form a 5- to 8-membered ring, provided that R₁, R₂ and R₃ do not represent a hydrogen atom at the same time. M₁ represents an alkali metal or an alkaline earth metal, and q represents 1 when M₁ represents an alkali metal or represents 2 when M₁ represents an alkaline earth metal. R₈₁ and R₈₂, which may be the same or different, each represents an alkyl group, an alkenyl group, an aryl group or a hetero ring group. M₂ represents an alkali metal, M₃ represents an alkali metal or an alkaline earth metal, u represents 2 when M₃ represents an alkali metal or represents 1 when M₃ represents an alkaline earth metal. R₉₁, R₉₂, R₉₃ and R₉₄, which may be the same or different, each represents a hydrogen atom, an alkyl group, an alkenyl group, an aryl group or a hetero ring group. At least two of R₉₁, R₉₂, R₉₃ and R₉₄ may be connected to each other to form a 5- to 8-membered ring.

The compounds represented by the formulae (A-I) to (D-VII) are described in more detail below. X represents a hydrogen atom, an alkali metal (e.g., lithium, sodium or potassium) or an alkaline earth metal (e.g., calcium, barium or magnesium). The alkyl group in the definition of R₁₀, R₂₀, R₂₁, R₂₂, R₃₀, R₃₁, R₄₀, R₄₁, R₄₂, Y, R₈₁, R₈₂, R₉₁, R₉₂, R₉₃, R₉₄, R₆₀ and R₆₁ represents a straight, branched or cyclic alkyl group (e.g., methyl, ethyl, propyl, i-propyl, t-butyl, cyclohexyl, t-hexyl, t-octyl, dodecyl, hexadecyl, octadecyl or benzyl), the alkenyl group in the definition of R₁₀, R₂₀, R₂₁, R₂₂, R₃₀, R₃₁, R₄₀, R₄₁, R₄₂, Y, R₈₁, R₈₂, R₉₁, R₉₂, R₉₃, R₉₄, R₆₀ and R₆₁ represents a straight, branched or cyclic alkenyl group (e.g., vinyl, allyl, 2-pentenyl, cyclohexenyl, hexenyl, dodecenyl or octadecenyl), the aryl group in the definition of R₁₀, R₂₀, R₂₁, R₂₂, R₃₀, R₃₁, R₄₀, R₄₁, R₄₂, Y, R₈₁, R₈₂, R₉₁, R₉₂, R₉₃, R₉₄, R₆₀ and R₆₁ represents an aryl group of a single benzene ring or a polycondensed ring (e.g., phenyl, naphthyl or anthranyl), and the hetero ring group in the definition of R₁₀, R₂₀, R₂₁, R₂₂, R₃₀, R₃₁, R₄₀, R₄₁, R₄₂, Y, R₈₁, R₈₂, R₉₁, R₉₂, R₉₃, R₉₄, R₆₀ and R₆₁ represents a 5- to 7-membered ring containing as a ring-constituting atom at least one of a nitrogen atom, a sulfur atom and an oxygen atom (e.g., furyl, pyrrolyl, imidazolyl, pyridyl, purinyl, chromanyl, pyrrolidyl or morpholinyl).

R₁₀ represents an alkyl group, an alkenyl group or an aryl group. R₂₀, R₂₁ and R₂₂, which may be the same or different, each represents an alkyl group, an alkenyl group, an aryl group, an alkoxy group (e.g., methoxy, ethoxy, methoxyethoxy, octyloxy, benzyloxy, cyclohexyloxy, i-propoxy, tetradecyloxy or octadecyloxy), an alkenoxy group (e.g., vinyloxy, propenyloxy, cyclohexenyloxy, dodecenyloxy or octadecenyloxy), an aryloxy group (e.g., phenoxy or naphthoxy), an alkylthio group (e.g., methylthio, ethylthio, i-propylthio, cyclohexylthio, benzylthio, oxtylthio, dodecylthio, hexadecylthio or octadecylthio), an alkenylthio group (e.g., vinylthio, allylthio, cyclohexenylthio or hexadecenylthio) or an arylthio group (e.g., phenylthio or naphthylthio). R₃₀ and R₃₁, which may be the same or different, each represents an alkyl group, an alkenyl group or an aryl group. R₄₀ represents an alkyl group. R₄₁, R₄₂ and Y, which may be the same or different, each represents a hydrogen atom, an alkyl group, an alkenyl group, an aryl group, a hetero ring group, the same alkoxy, alkenoxy, aryloxy, alkylthio, alkenylthio or arylthio group as with R₂₀, a hetero ring oxy group (e.g., imidazolidinyloxy, morpholinyloxy, tetrahydropyran-3-yloxy or 1,3,5-triazin-2-yloxy), a hydroxyl group, an optionally substituted amino group (e.g., amino, alkylamino, arylamino, dialkylamino, acylamino, sulfonamide, ureido or urethane), a carbamoyl group (e.g., N-methylcarbamoyl, N-phenylcarbamoyl or N,N-diethylcarbamoyl), a sulfamoyl group (e.g., N-ethylsulfamoyl or N-phenylsulfamoyl), an alkoxycarbonyl group (e.g., methoxycarbonyl, butoxycarbonyl, cyclohexyloxycarbonyl, octyloxycarbonyl, hexyloxycarbonyl or octadecyloxycarbonyl), an aryloxycarbonyl group (e.g., phenyloxycarbonyl or naphthyloxycarbonyl), a halogen atom (e.g., fluorine atom, chlorine atom or bromine atom), a nitro group, a cyano group, an acyl group (e.g., acetyl, benzoyl or naphthoyl) or an acyloxy group (e.g., acetyloxy, benzoyloxy or naphthoyloxy). m represents an integer of 0 to 2. R₆₀ and R₆₁, which may be the same or different, each represents an alkyl group, an alkenyl group, an aryl group or a hetero ring group. Z represents the same group as defined for Y, and n represents an integer of 0 to 4. When m represents 2, a plurality of Y's may be the same as or different from each other and, when n represents an integer of 2 to 4, a plurality of Z's may be the same as or different from each other. R₂₀ and R₂₁, or R₃₀ and R₃₁, may be connected to each other to form a 5- to 7-membered ring.

R₁, R₂ and R₃, which may be the same or different, each represents a hydrogen atom, an aliphatic group, an aromatic group, a hetero ring group or an amino group. At least two of R₁, R₂ and R₃ may be connected to each other to form a 5- to 8-membered ring. Also, R₁ and R₂ may cooperate to form an unsaturated group, with the unsaturated group being connected to R₃ to form a 5- to 8-membered ring, provided that R₁, R₂ and R₃ do not represent a hydrogen atom at the same time. The aliphatic group as used herein represents a straight, branched or cyclic alkyl group (e.g., methyl, ethyl, propyl, i-propyl, t-butyl, cyclohexyl, t-hexyl, t-octyl, dodecyl, hexadecyl, octadecyl or benzyl), an alkenyl group (e.g., vinyl, allyl, 2-pentenyl, cyclohexenyl, hexenyl, dodecenyl or octadecenyl) or an alkynyl group (e.g., propynyl or hexadecynyl), with these groups being optionally substituted. The aromatic group as used herein represents an aryl group of a single benzene ring or a condensed polycyclic ring (e.g., phenyl, naphthyl or anthranyl). These rings may have a substituent. The hetero ring group as used herein represents a 5- to 7-membered ring containing as a ring-constituting atom at least one of a nitrogen atom, a sulfur atom and an oxygen atom (e.g., furyl, pyrrolyl, imidazolyl, pyridyl, purinyl, chromanyl, pyrrolidyl or morpholinyl). The amino group as used herein may be an unsubstituted amino group or an N-substituted amino group.

Examples of the substituents which the above-mentioned groups may optionally have include an aliphatic group, an aromatic group, a hetero ring group, an acyl group, a sulfonyl group, a sulfamoyl group and a carbamoyl group.

At least two of R₁, R₂ and R₃ may be connected to each other to form a 5- to 8-membered ring (e.g., a pyrrolidine ring, an imidazoline ring, an imidazolidine ring, a pyrazolidine ring, a piperazine ring, a piperidine ring, a morpholine ring, an indoline ring or a quinuclidine ring) R₁ and R₂ may cooperate to form an unsaturated group, with the unsaturated group being connected to R₃ to form a 5- to 8-membered ring (e.g., a pyridine ring, a quinoline ring, a pteridine ring or a phenanthroline ring).

M₁ represents an alkali metal (e.g., lithium, sodium or potassium) or an alkaline earth metal (e.g., calcium, barium or magnesium). R₈₁ and R₈₂, which may be the same or different, each represents an alkyl group, an alkenyl group, an aryl group or a hetero ring group. The alkyl group as used herein represents a straight, branched or cyclic alkyl group (e.g., methyl, ethyl, propyl, i-propyl, t-butyl, cyclohexyl, t-hexyl, t-octyl, dodecyl, hexadecyl, octadecyl or benzyl), the alkenyl group represents a straight, branched or cyclic alkenyl group (e.g., vinyl, allyl, 2-pentenyl, cyclohexenyl, hexenyl, dodecenyl or octadecenyl) and the aryl group represents an aryl group of a single benzene ring or a condensed polycyclic ring (e.g., phenyl, naphthyl or anthranyl). The hetero ring group as used herein represents a 5- to 7-membered ring containing as a ring-constituting atom at least one of a nitrogen atom, a sulfur atom and an oxygen atom (e.g., furyl, pyrrolyl, imidazolyl, pyridyl, purinyl, chromanyl, pyrrolidyl or morpholinyl). M₂ represents an alkali metal (e.g., lithium, sodium or potassium). M₃ represents an alkali metal (e.g., lithium, sodium or potassium) or an alkaline earth metal (e.g., calcium, barium or magnesium).

R₉₁, R₉₂, R₉₃ and R₉₄, which may be the same or different, each represents an alkyl group, an alkenyl group, an aryl group or a hetero ring group. The alkyl group as used herein represents a straight, branched or cyclic alkyl group (e.g., methyl, ethyl, propyl, i-propyl, t-butyl, cyclohexyl, t-hexyl, t-octyl, dodecyl, hexadecyl, octadecyl or benzyl), the alkenyl group represents a straight, branched or cyclic alkenyl group (e.g., vinyl, allyl, 2-pentenyl, cyclohexenyl, hexenyl, dodecenyl or octadecenyl) and the aryl group represents an aryl group of a single benzene ring or a condensed polycyclic ring (e.g., phenyl, naphthyl or anthranyl). The hetero ring group represents a 5- to 7-membered ring containing as a ring-constituting atom at least one of a nitrogen atom, a sulfur atom and an oxygen atom (e.g., furyl, pyrrolyl, imidazolyl, pyridyl, purinyl, chromanyl, pyrrolidyl or morpholinyl).

R₉₁ and R₉₂, or R₉₃ and R₉₄, may be connected to each other to form a 5- to 8-membered ring (e.g., (e.g., a pyrrolidine ring, an imidazoline ring, an imidazolidine ring, a pyrazolidine ring, a piperazine ring, a piperidine ring, a morpholine ring, an indoline ring or a quinuclidine ring).

Of the compounds represented by formula (A-II), those wherein all of R₂₀ to R₂₂ are selected from among an alkyl group, an aryl group, an alkoxy group and an aryloxy group are preferred. Those wherein all of R₂₀ to R₂₂ are selected from among an alkyl group, an aryl group and an aryloxy group are more preferred. Among the compounds having an aryloxy group, those wherein the benzene ring of the aryloxy group has a substituent at o-position thereof are preferred. Among the compounds wherein at least two or R₂₀ to R₂₂ are an aryloxy group, those wherein o-position of one benzene ring is connected to o-position of the other benzene ring directly or through the substituent at the o-position are preferred.

Of the compounds represented by formula (B-I), those which are represented by the following formulae (B-I-I) and (B-I-II) are preferred.

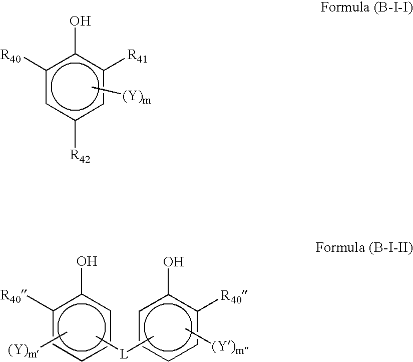

In the formulae, R₄₀, represents a tertiary alkyl group, R₄₀″ and R₄₀″′, which may be the same or different, each represents an alkyl group, and L represents a single bond or the following linking group.

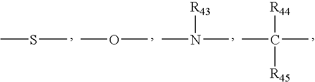

In the linking group, R₄₃ represents a hydrogen atom, an alkyl group or an aryl group. R₄₄ and R₄₅, which may be the same or different, each represents a hydrogen atom, an alkyl group or an aryl group. In the above formulae, R₄₁, R₄₂, Y and m are the same as defined for formula (B-I), and Y′ is the same as defined for Y. m′ and m″ are the same as defined for m.

Of the compounds represented by formula (D-I), those which have a pKa of 4 or more are preferred, those which have a pKa of 4 to 9 are more preferred, and those which have a pKa of 5 to 8 are still more preferred. The most preferred are amine compounds having a pKa of 5 to 7. The pKa is a dissociation constant of a conjugate acid of the amine compound, and is a value determined in a mixed solvent of EtOH/H₂O=4/1 at room temperature. Generally, this value is obtained by a titrimetric method. Further, the amine compound is preferably an oleophilic compound containing in total 8 or more carbon atoms, more preferably 15 or more carbon atoms.

The amine compound is preferably a tertiary amine. Of the compounds represented by formula (D-I), the most preferred compounds are oleophilic compounds which are represented by the following formula (D-I-I) and which have a pKa of 4 or more.

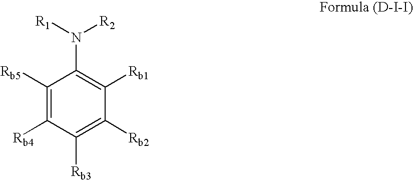

In formula (D-I-I), R₁ and R₂ are the same as defined with respect to formula (D-I). R_{b1} to R_{b5}, which may be the same or different, each represents a hydrogen atom, an aliphatic group, an aromatic group, a hetero ring group, an aliphatic oxy group, an aromatic oxy group, a hetero ring oxy group, an aliphatic thio group, an aromatic thio group, a hetero ring thio group, a hydroxyl group, a halogen atom, a cyano group, a nitro group, an amino group which may have a substituent, a sulfonyl group, an acyl group, an acyloxy group, a sulfamoyl group, a carbamoyl group or an ester group. R₁ and R₂, R₁ and R_{b5}, R₂ and R_{b1}, or two of R_{b1} to R_{b5} in an o-position with each other, may be connected to each other to form a 5- to 8-membered ring.

As preferred acid-captivating agents (D) of the invention, there are also illustrated amine compounds represented by the foregoing formula (D-VIII) other than the above-described compounds.

In formula (D-VIII), X represents a single bond or a 2- to 3-valent organic residue, B₁ represents an amino group-having aryl group, an aryloxy group or a nitrogen-containing hetero ring group, provided that X₁ does not represent —O— and —(CH₂)₄—. p represents 2 or 3. Examples of X₁ include 2- and 3-valent residues which connects to B₁ through a single bond, carbon atom, nitrogen atom or phosphorus atom, and divalent linking groups such as —S—, —SO₂—, —O—Ar—O—, —O—Ar—(CR₄R₅)ₙ—Ar—O—, —O—Ar—SO₂—Ar—O—, —O—CH₂—Y₁—CH₂—O—. Here, Ar represents an aryl group, R₄ and R₅ each represents an alkyl group, Y₁ represents CR₄R₅ or —CH₂OCH₂—. B₁ is an amino group-having aryl group, an aryloxy group or a nitrogen-containing hetero ring group having a pKa (value measured in a mixed solvent of ethanol/water=4/1) of 4 or more. The amino group may be unsubstituted or have a substituent. Examples of the substituent include an alkyl group, a cycloalkyl group, an aralkyl group, an aryl group and a hetero ring group. As the amino group, a tertiary amino group is particularly preferred, and a cyclic tertiary amino group is also preferably used. Examples of the nitrogen-containing hetero ring group include a pyrrolidino group, a piperidino group, a morpholino group, a piperazino group, a pyridyl group, a pyrimidyl group, a quinolyl group, an imidazolyl group, a pyrrolyl group, an indolino group, a tetrahydroquinolyl group, an imidazolinyl group, a thiazolinyl group, an imidazolidinyl group and a thiazolidinyl group. The amino groups and the nitrogen-containing hetero ring groups may further have other substituents.

Of the amine compounds of the invention represented by formula (D-VIII), those compounds which have a molecular weight of 300 or more and have substantially no vaporizing property are more preferred.

Of the amine compounds of the invention represented by formula (D-VIII), those compounds which have substantially no vaporizing property and have a molecular weight of 200 or less per basic group are the most preferred.

Of the compounds represented by formula (B-I), those compounds which have a pKa of 4 to 9 are more preferred, those compounds which have a pKa of 5 to 8 are still more preferred, and those compounds which have a pKa of 5 to 7 are most preferred.

Specific examples of the compounds of the invention represented by formulae (A-I) to (D-VIII) include those compounds which are described in [0063] to [0064] of JP-A-5-197073.

Most of these compounds are commercially available, and are easily available. Other preferred examples of the amine compounds represented by the formulae (D-I) and (D-VIII) and synthesizing processes thereof are described in U.S. Pat. Nos. 4,483,918, 4,555,479, 4,585,728, 4,639,415, European Unexamined Patent No. 264,730, JP-A-58-102231, JP-A-59-229557, JP-A-61-73152, JP-A-63-98662, JP-A-63-115167. and JP-A-63-267944.

Next, the cellulose acylate film containing organic chlorine-containing solvents in a content of as low as 10 ppm or less.

In order to reduce the content of organic chlorine-containing solvents (mainly methylene chloride) in the film immediately after production, it is preferred to form a cellulose acylate layered film which has a core layer comprising cellulose acylate having a substitution degree of 2.7 or less and has at least on one side of the core layer a surface layer having a thickness of 0.5 μm to 15 μm and comprising cellulose acylate having a substitution degree of 2.8 or more. This cellulose acylate layered film can be produced by solution filming the surface layer having a thickness of 0.5 μm to 15 μm and comprising cellulose acylate having a substitution degree of 2.8 or more using a dope prepared from a solvent containing methylene chloride or N-methyl-2-pyrrolidone in a concentration of 70% or more, and solution filming the core layer comprising cellulose acylate having a substitution degree of 2.7 or less from a solvent containing acetone in a concentration of 60% or more.

The cellulose acylate layered film of the invention having a layered structure wherein the surface layer has cellulose acylate of 2.8 or more in substitution degree and the core layer has cellulose acylate of 2.7 or less in substitution degree permits to markedly reduce the content of contained solvents and provide a film having excellent resistance to moist heat. A film formed from cellulose acylate of 2.8 or more in substitution degree (hereinafter also referred to as “TAC” with the case of cellulose acetate) has excellent characteristic properties that it has much less water vapor permeability than a film formed from cellulose acylate of 2.7 or less in substitution degree (hereinafter also referred to as “DAC” with the case of cellulose acetate).

Descriptions are given below taking cellulose acetate for instance. TAC (cellulose acylate of 2.8 or more in substitution degree) having a less water vapor permeability provided on the surface layer of DAC (cellulose acylate of 2.7 or less in substitution degree) can prevent invasion of moisture from outside atmosphere, thus DAC having only insufficient resistance to moist heat being protected. As a result, the whole film has a good resistance with time against moisture and heat.

The substitution degree of the cellulose acylate of 2.8 or more in substitution degree or TAC is preferably 2.8 to 3.0, more preferably 2.9 to 3.0. The substitution degree of the cellulose acylate of 2.7 or less in substitution degree or DAC is preferably 2.0 to 2.7, more preferably 2.5 to 2.7.

Additionally, the term “substitution degree” as used herein means a proportion of hydroxyl group esterified with a fatty acid based on the hydroxyl group of cellulose.

The substitution degree can be determined according to ASTM-D817-96.

First, in order to determine acetylation degree, dried cellulose acylate was weighed and dissolved in a mixed solution of acetone and dimethylsulfoxide (4:1 by volume). Then, a predetermined amount of 1 mol/liter sodium hydroxide aqueous solution was added to the solution, followed by conducting saponification at 25° C. for 2 hours. Phenolphthalein was added thereto as an indicator, and excess sodium hydroxide was titrated with 0.5 mol/liter sulfuric acid (concentration factor: F). A blank test was conducted in the same manner as described above. The acetylation degree (%) was calculated according to the following formula:
Acetylation degree (%)=(6.005×(B−A)×F)/W

In the above formula, A represents the amount (ml) of 0.5 mol/liter sulfuric acid required for titrating a sample, B represents the amount (ml) of 0.5 mol/liter sulfuric acid, F represents a factor of 0.5 mol/liter sulfuric acid, and W represents the weight of the sample. Additionally, in the system containing plural kinds of acyl groups, the amount of each acyl group was determined using the difference in pKa. Also, acetylation degree was also determined according to the method described in a document (T. Sei, K. Ishitani, R. Suzuki, K. Ikematsu; Polymer Journal 17, 1065, 1985). Further, the thus determined acetylation degree or other acylation degree was converted to substitution degree taking the molecular weight into consideration. Still further, acyl substitution degrees in 2-, 3- and 6-positions of cellulose acylate were determined by acylating cellulose acetate with an acyl group not used for the former acylation, then subjecting to 13C-NMR in a manner described in Tezuka et al., Carbohydr. Res. 273 (1995), 83-91.

In the invention, the cellulose acylate film having the aforementioned layered structure include a 2-layer structured cellulose acetate film comprising a surface layer of TAC and an adjacent layer of DAC, and a 3-layer structured cellulose acetate film comprising a core layer of DAC having provided on both sides thereof a surface layer of TAC. Further, films comprising three or more layers are also included. In the 3-layer structured film of the invention, the thicknesses of the two surface layers may not be the same, but are preferably the same in view of balancing mechanical properties of the film. The 2-layer structured cellulose acetate film of the invention can fully attain the object of preventing moisture by providing a functional film such as a polarizing film or a light-sensitive film on the surface of DAC constituting the core layer. The subject of moisture-proof storage of the 2-layer structured film can be solved by rolling the film and wrapping it in a moisture-proof state. In the invention, layered films having three or more layers wherein the TAC surface layer is provided on both sides of the DAC core layer are preferred. This structure permits to prevent invasion of moisture into the film under any storage condition and maintain excellent transparency, dimensional stability and resistance to moist heat of the film for a long period of time.

Further, since the surface layer having TAC is as thin as 0.5 to 15 μm, the amount of an organic solvent to be used can be remarkably reduced, which serves to improve safety in working environment and surrounding environment and, further, solve the problem of haze caused by remaining solvent. Here, the thickness of the layer having TAC is preferably 0.5 to 10 μm, more preferably 1.0 to 5.0 μm.

The above description made by reference to cellulose acetate can be applied to other cellulose acylates.

In the case of using organic chlorine-containing solvents in filming TAC, the content of the organic chlorine-containing solvent contained in the film immediately after its production can be reduced to 10 ppm or less under about the same conditions as the drying condition for conventional cellulose triacetate film. The content of the organic chlorine-containing solvent is preferably 5 ppm or less. Thus, a more safety in working environment and surrounding environment can be obtained and, further, the problem of haze to be caused by the remaining solvent can be markedly solved. In the invention, even when the two surface layers of the 3-layer structured film are formed from cellulose acylate dissolved in methylene chloride, the content of the organic chlorine-containing solvent (mainly methylene chloride) contained in the film immediately after its production can be reduced to 10 ppm or less.

It has been practically impossible to provide a cellulose acylate film containing an organic chlorine-containing solvent in a content of 10 ppm or less, because the conventional method of forming a film of 50 μm or more in thickness from a dope containing methylene chloride fails to provide a film of 10 ppm or less in the content of the organic chlorine-containing solvent unless a seriously drying operation is conducted.

Also, the boiling point of N-methyl-2-pyrrolidone (NMP) is higher than the boiling point of methylene chloride, resulting in a seriously large amount of the remaining solvent. In the invention, however, the thickness of the TAC-having layer is so thin (at most 15 μm) that, even when the two surface layers are formed as with the 3-layer structured film, the amount of remaining NMP immediately after production of the film can be reduced to 2000 ppm or less. The amount of remaining NMP is preferably 1500 ppm or less. Thus, a drying load for drying the surface layers is not large and causes no problems in producing the film. Also, since the amount of the remaining solvent is small and the chlorine-containing solvents are not used for the filming, there does not arise the problem of remaining of the chlorine-containing solvent. Further, haze having been caused due to a large amount of remaining NMP can be prevented, thus transparency of a film during storage being kept at a proper level.

As to the cellulose acylate film produced using a chlorine-free solvent and the process for its production, detailed descriptions are given in Hatsumei Kyokai Kokai Giho 2001-1745.

Next, a cellulose acylate film containing a polyhydric alcohol ester of an aliphatic polyhydric alcohol and one or more monocarboxylic acids is described below. The aliphatic polyhydric alcohol ester of the invention is an ester of an aliphatic polyhydric alcohol having 2 or more hydroxyl groups and one or more monocarboxylic acids.

The aliphatic polyhydric alcohol to be used in the invention is an alcohol having 2 or more hydroxyl groups and is represented by the following formula (a):
R₁₁—(OH)ₙ

In the formula (a), R₁₁ represents an n-valent aliphatic organic group, n represents a positive integer of 2 or more, and OH group represents an alcoholic and/or phenolic hydroxyl group.

Examples of the n-valent organic group include an alkylene group (e.g. methylene, ethylene, trimethylene or tetramethylene), an alkenylene group (e.g., etenylene), an alkynylene group (e.g., ethynylene), a cycloalkylene group (e.g., 1,4-dyclohexanediyl) and an alkanetriyl group (e.g., 1,2,3-propanetriyl). The n-valent aliphatic organic group include those which have a substituent (e.g., a hydroxyl group, an alkyl group or a halogen atom). n is preferably 2 to 20, more preferably 2 to 5, particularly preferably 2 or 3.

Examples of preferred polyhydric alcohol include adonitol, arabitol, ethylene glycol, diethylene glycol, triethylene glycol, tetraethylene glycol, 1,2-propanediol, 1,3-propanediol, dipropylene glycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane and xylitol. In particular, triethylene glycol, tetraethylene glycol, dipropylene glycol, tripropylene glycol, sorbitol, trimethylolpropane and xylitol are preferred.

The monocarboxylic acid to be used in the polyhydric alcohol ester of the invention is not particularly limited, and any of known aliphatic monocarboxylic acids, alicyclic monocarboxylic azcids and aromatic monocarboxylic acids may be used. Use of the alicyclic monocarboxylic acid or the aromatic monocarboxylic acid is preferred in view of improving water vapor permeability of the resulting cellulose acylate film.

As examples of preferred monocarboxylic acid, there may be illustrated the following ones which, however, do not limit the invention.

As the aliphatic monocarboxylic acid, fatty acids having a straight or branched chain containing 1 to 32 carbon atoms may preferably be used. The number of carbon atoms is more preferably 1 to 20, particularly preferably 1 to 10. Existence of acetic acid is preferred because it increases compatibility for the cellulose ester, and it is also preferred to use a mixture of acetic acid and other monocarboxylic acid.

Examples of preferred aliphatic monocarboxylic acids include saturated fatty acids such as acetic acid, propionic acid, butyric acid, valeric acid, caproic acid, enanthic acid, capric acid, pelargonic acid, capric acid, 2-ethyl-hexanecarboxylic acid, undecylic acid, lauric acid, tridecylic acid, myristic, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid and lacceric acid, and unsaturated fatty acids such as undecylenic acid, oleic acid, sorbic acid, linoleic acid, linolenic acid and arachidonic acid. These may further have a substituent.

Preferred examples of the alicyclic monocarboxylic acids include cyclopentanecarboxylic acid, cyclohexanecarboxylic acid, cyclooctanecarboxylic acid and the derivatives thereof.

Preferred examples of the aromatic monocarboxylic acids include benzoic acid, those wherein an alkyl group is introduced into the benzene ring of benzoic acid such as toluic acid, aromatic monocarboxylic acids having two or more benzene rings such as biphenylcarboxylic acid, naphthalenecarboxylic acid and tetralincarboxylic acid and the derivatives thereof, with benzoic acid being particularly preferred.

The polyhydric alcohol esters to be used in the invention are not particularly limited as to molecular weight. However, the molecular weight is preferably 300 to 1500, more preferably 350 to 750.

The carboxylic acids in the polyhydric alcohol esters of the invention may be used alone or as a mixture of two or more thereof. Also, all OH groups in the polyhydric alcohol may be esterified, or part of OH groups may be remained as OH group. It is preferred for the ester to have 3 or more aromatic or cycloalkyl rings within the molecule.

Specific examples of the polyhydric alcohol esters to be used in the invention are shown below which, however, do not limit the invention.

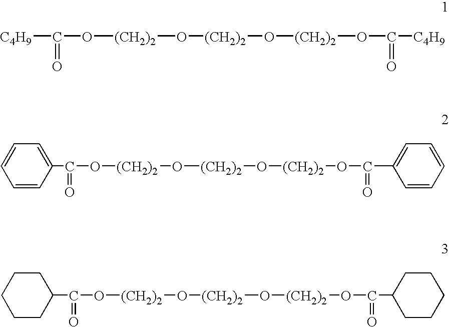

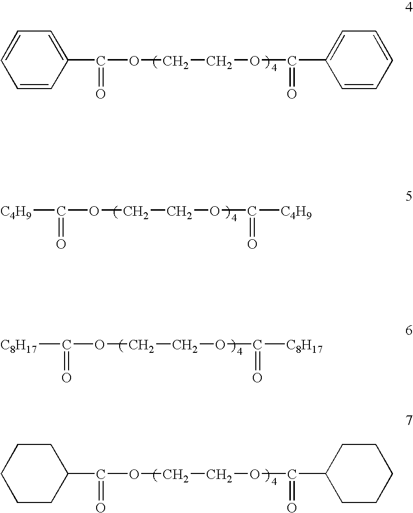

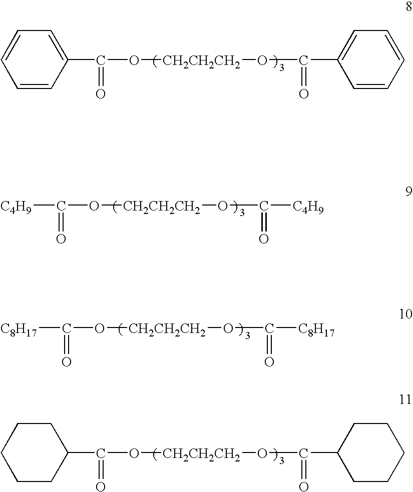

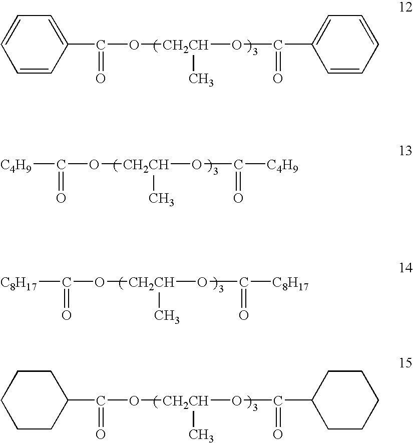

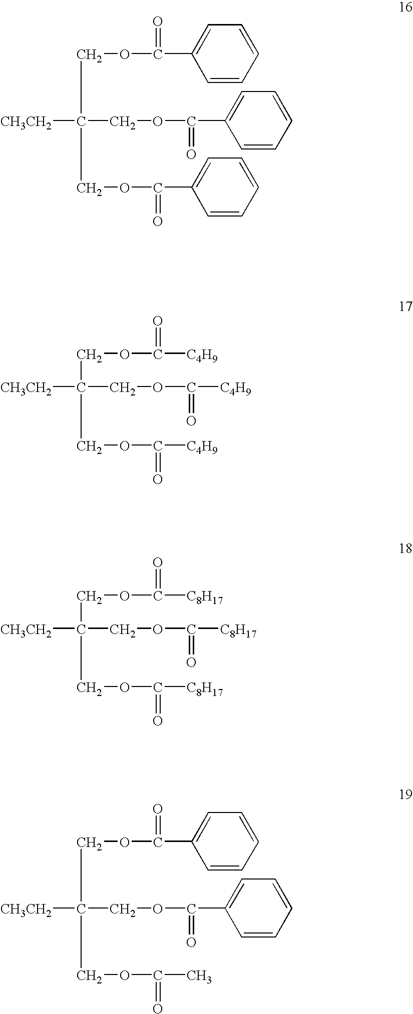

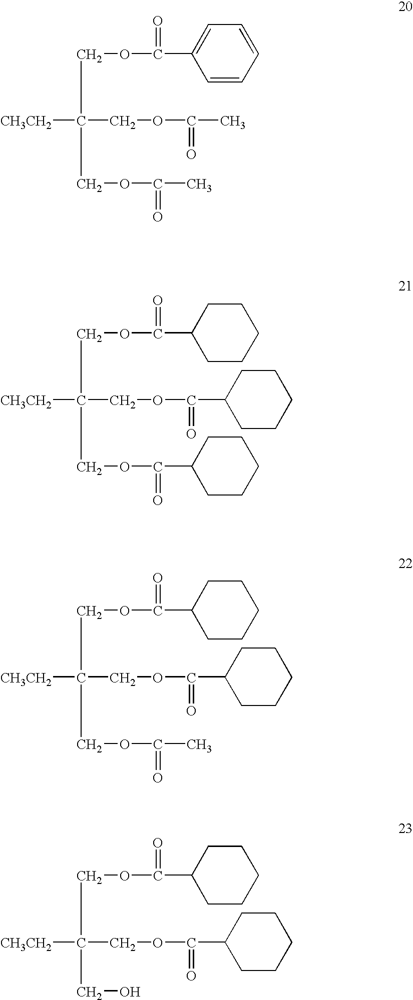

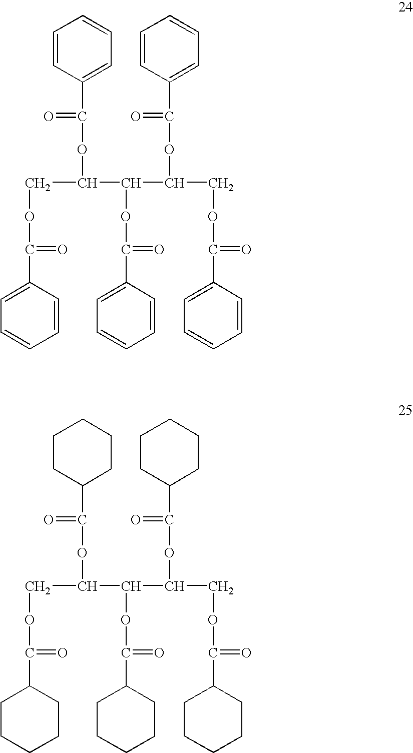

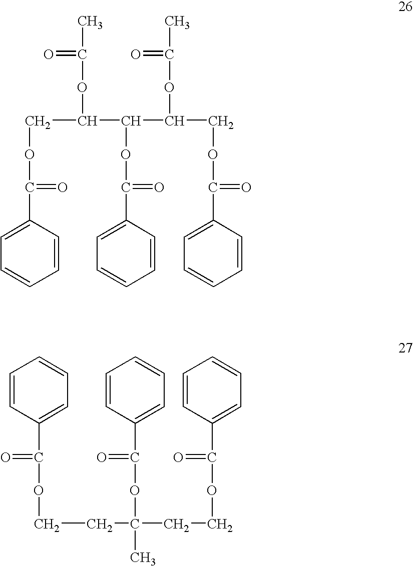

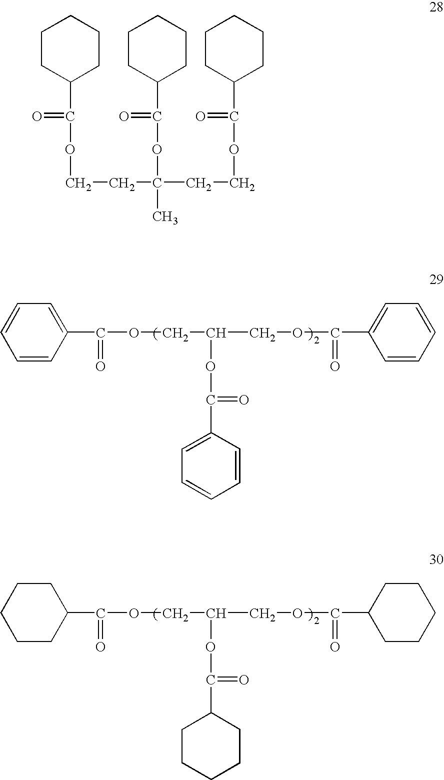

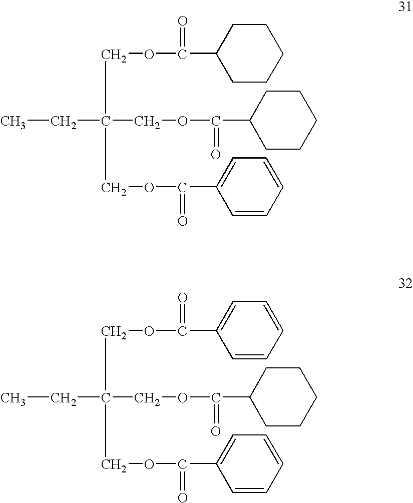

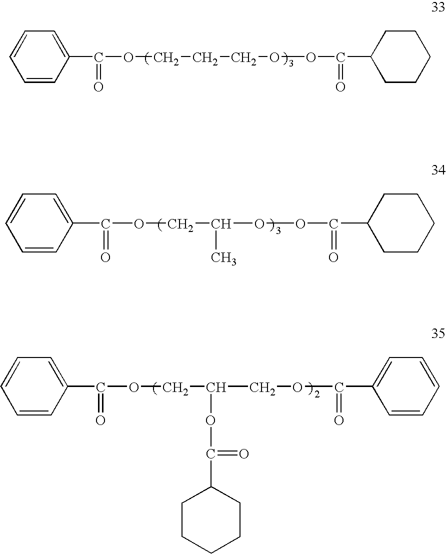

The amount of polyhydric alcohol ester is preferably 3 to 30% by weight, more preferably 5 to 25% by weight, particularly preferably 5 to 20% by weight, based on the cellulose acylate.

These polyhydric alcohol esters are preferably used in place of phosphates such as triphenyl phosphate conventionally used by mixing into cellulose acylate. That is, the esters are preferably used for a cellulose acylate film having the phosphate in a reduced amount of 0.1 g/m² or having no such phosphate.

As the polycarbonate film to be used in the invention, the film described in [0023] of JP-A-2003-157579 can preferably be used.

Next, the cyclic polyolefin film to be used in the invention is described below.

The cyclic polyolefin film to be used in the invention is described in JP-A-5-65350, JP-A-6-107736, JP-A-6-248164, JP-A-10-60048, JP-A-11-129399, JP-A-11-216817, JP-A-11-217446, JP-A-11-217491, JP-A-2001-9859, JP-A-2001-163959 and JP-A-2002-249625.

The cyclic polyolefin to be used in the invention has an alicyclic structure in the main chain and/or side chain. In view of mechanical strength and heat resistance, those which have the alicyclic structure in the main chain are preferred. Examples of the alicyclic structure of the polymer include a cycloalkane structure and a cycloalkene structure and, in view of mechanical strength and heat resistance, the cycloalkane structure and the cycloalkene structure are preferred. Of them, those which have the cycloalkane structure are most preferred since they have excellent weatherability and chemical resistance. The number of carbon atoms constituting the alicyclic structure is not particularly limited, but is usually 4 to 30, preferably 5 to 20, more preferably 5 to 15, because the alicyclic structure with such carbon atom number shows a highly balanced mechanical strength, heat resistance and moldability.

The proportion of the repeating unit having the alicyclic structure in the cyclic polyolefin to be used in the invention may properly be selected depending upon the end-use thereof, but is usually 30% by weight or more, preferably 50% by weight or more, more preferably 70% by weight or more. In case where the proportion of the repeating unit having the alicyclic structure in the cyclic polyolefin is too small, there results a film with a poor heat resistance, thus such proportion not being preferred. The remaining portion of the cyclic polyolefin other than the repeating unit having the alicyclic structure in the cyclic polyolefin is not particularly limited and may properly be selected depending upon the end-use. As the cyclic polyolefin, thermoplastic olefins are preferred.

Specific examples of the polymer having the alicyclic structure include (1) norbornene-based polymers, (2) monocyclic olefin-based polymers, (3) cyclic conjugated diene-based polymers, (4) vinyl-alicyclic hydrocarbon polymers, and the hydrogenated products thereof. Of these, norbornene-based polymers and the hydrogenated products thereof, cyclic conjugated diene-based polymers and the hydrogenated products thereof are preferred, with norbornene-based polymers and the hydrogenated products thereof being more preferred.

(1) Norbornene-Based Polymers

The norbornene-based polymers are not particularly limited and, for example, those obtained by polymerizing a norbornene-based monomer (a cyclic olefin monomer having a norbornene ring) by the processes disclosed in JP-A-3-14882 and JP-A-3-122137 may be used. Specific examples thereof include a ring opening polymerization product of a norbornene-based monomer and the hydrogenated products thereof, an addition polymer of a norbornene-based monomer, and an addition polymerization product between a norbornene-based monomer and a vinyl compound.

Of these, a hydrogenated product of a ring opening polymerization product of a norbornene-based monomer, an addition polymer of a norbornene-based monomer, and an addition polymerization product between a norbornene-based monomer and a copolymerizable vinyl compound are preferred, with a hydrogenation product of a ring opening polymerization product of a norbornene-based monomer being particularly preferred. The hydrogenation product of a ring opening polymerization product of a norbornene-based monomer has a plasticization temperature and a decomposition temperature widely different from each other and is therefore suited for calendar molding which involves heating. Thus, it permits molding of a film having an excellent mechanical strength and an excellent appearance.

Examples of the norbornene-based monomer include those which are described in paragraphs [0010] to [0013] in JP-A-2001-9859 such as bicyclo[2.2.1]hept-2-ene (conventionally called norbornene).

These norbornene-based monomers are used independently or in combination of two or more thereof. Of the norbornene-based monomers, dicyclopentadiene is preferably used in combination. Examples of the combination include a combination of dicyclopentadiene and tetracyclododecene, a combination of dicyclopentadiene, tetracyclododecene and ethyltetracyclododecene, a combination of dicyclopentadiene and ethyltetracyclododecene, a combination of dicyclopentadiene and ethylidenetetracyclododecene and a combination of dicyclopentadiene and 1,4-methano-1,4,4a,9a-tetrahydrofluorene.

Examples of the vinyl compound copolymerizable with the norbornene-based monomer include ethylene or α-olefins containing 2 to 20 carbon atoms such as ethylene, propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene and 1-eicosene; cycloolefins such as cyclobutene, cyclopentene, cyclohexene, 3,4-dimethylcyclopentene, 3-methylcyclohexene, 2-(2-methylbutyl)-1-cyclohexene, cyclooctene and 3a,5,6,7a-tetrahydro-4,7-methano-1H-indene; and non-conjugated dienes such as 1,4-hexadiene, 4-methyl-1,4-hexadiene, 5-methyl-1,4-hexadiene and 1,7-octadiene. These vinyl compounds may be used independently or in combination of two or more thereof.

Processes for poloymerizing the norbornene-based monomer or copolymerizing the norbornene-based monomer and the copolymerizable vinyl compound and processes for hydrogenating the products are not particularly limited, and may be conducted in a known manner.

(2) Monocyclic Olefin-Based Polymers

As the monocyclic olefin-based polymer, addition polymerization products of a monocyclic olefin-based monomer such as cyclohexene, cycloheptene or cyclooctene disclosed in JP-A-64-66216 may be used.

(3) Cyclic Conjugated Diene-Based Polymers

As the cyclic diene-based polymers, 1,2- or 1,4-addition polymerization products of cyclic conjugated diene-based monomers such as cyclopentadiene and cyclohexadiene and the hydrogenated products thereof disclosed in JP-A-6-136057 and JP-A-7-258318 may be used.

(4) Hydrocarbon-Based Polymers Having an Alicyclic Structure in the Side Chain

As the hydrocarbon-based polymers, polymers of a vinyl-alicyclic hydrocarbon monomer such as vinylcyclohexene or vinylcyclohexane, the hydrogenated products thereof, and hydrogenated products of a styrene-based polymer may be used.

The molecular weight of the cyclic polyolefin to be used in the invention is properly selected depending upon the end-use thereof, and the number-average molecular weight is usually 5,000 to 500,000, preferably 8,000 to 200,000, more preferably 10,000 to 100,000 in terms of polyisoprene measured according to gel permeation chromatography in a cyclohexane solution (or toluene solution when the polymer resin is not dissolved in cyclohexane), and the weight-average molecular weight is usually 10,000 to 1,000,000, preferably 15,000 to 500,000, more preferably 20,000 to 200,000. MWD (=weight-average molecular weight/number-average molecular weight) is usually 1.0 to 10, preferably 1.0 to 6, more preferably 1.1 to 4. The mechanical strength and moldability of the film are well balanced with each other by adjusting the molecular weight within such range.

The glass transition temperature (Tg) of the cyclic polyolefin to be used in the invention may properly be selected depending upon the end-use thereof, and is preferably 50 to 200° C. or higher, more preferably 70 to 150° C. or higher, most preferably 80 to 120° C. When the Tg falls within this range, yellowing to be caused due to oxidative deterioration of the film upon plasticization of the resin in calendar molding becomes difficult to take place, and the resultant film acquires good heat resistance.

The cyclic polyolefin to be used in the invention has a temperature of 5% weight loss upon heating (measured under nitrogen atmosphere at a temperature-increasing rate of 5° C./min) is preferably 280° C. or higher, particularly preferably 350° C. or higher. When the temperature of 5% weight loss upon heating of the cyclic polyolefin is within this range, decomposition of the resin is difficult to take place even when the resin temperature is raised to a high temperature, and molding failure such as formation of foam within a resulting molding due to decomposition of the resin can be prevented, thus such polyolefin being preferred.

The melt viscosity at 260° C. of the cyclic polyolefin to be used in the invention is usually 1×10¹ to 1×10⁵ poises, preferably 1×10² to 1×10³ poises. When the melt viscosity is within this range, moldability of the film is well balanced with mechanical strength of the film, thus such polyolefin being preferred.

(Additives)

To the cyclic polyolefin to be used in the invention may be added, if necessary, other polymers, antioxidants, deterioration-preventing agents, lubricants, light stabilizers, UV ray absorbents, fillers, colorants, cross-linking agents, curing agents, plasticizers and foaming agents independently or in combination of two or more thereof.

In the case of adding various additives, they can be added in the production step of the cyclic polyolefin resin or in the step of kneading, mixing or melting the cyclic polyolefin resin after production of the resin.

In producing the cyclic polyolefin film, the cyclic polyolefin is melted by heating to a temperature higher than the glass transition temperature of the polyolefin by 30 to 150° C., preferably 70 to 120° C. The method of melting by heating can be conducted according to the known method. For example, it can be conducted using an extruder or a kneader. Of the extruders, a strainer is preferred because it can filtrate out foreign matters which might be contained in the resin and can feed the compound with a uniform temperature distribution to a calendar roll. The strainer has the same structure as that of the extruder, except that a wire gauze of about 20-mesh or more, preferably 60-mesh or more, is provided at its front. As a special strainer, there is a micro-strainer wherein a super-mixer is combined with an extruder.

In producing the cyclic polyolefin film, the molten resin is introduced into the roll gap between a set of juxtaposed calender rolls rotating in reverse directions, then drawn in a film form. At least two calender rolls are provided, and they are arranged in the same manner as is conducted with rubbers or vinyl chloride resin.

Manner of arrangement includes 3 fundamental arrangements of a vertical type, a horizontal type and an inclined type, which may be combined to constitute a Z type, a reverse L type, [symbol] type, a camel back type or an M type. Further, various combination is possible by changing the number of rolls from 2 rolls to ten and a few rolls. Also, as apparatuses to be attached to the calender rolls, a cooling roll, a carrying roll, a pressure roll may be used in combination. Specific examples include 2 vertical rolls, 2 inclined rolls, 3 vertical rolls, 4 vertical coating rolls, 2 vertical and 4 reverse L type rolls, 3 pairs of 2 vertical and 2 horizontal rolls, 2 vertical, 4 reverse L type and 1 cooling rolls, 5 [symbol] type and 1 cooling rolls, 4 camel back type and 1 cooling rolls, a pair of 3 vertical rolls, 4 reverse L type and 2 pressure rolls, 4 Z type and 2 pressure rolls, 2 horizontal rolls, 3 reverse L type rolls, 4 vertical rolls, 4 reverse L type rolls, 4 camel back type rolls, 3 vertical and 1 cooling rolls, 4 reverse L type and 1 cooling rolls, 4 Z type and 1 cooling rolls, 3 vertical and 1 carrying rolls, 4 Z type and 4 cooling rolls, and 4 reverse L type and 5 cooling rolls.

The temperature of calender rolls (a set of rolls between which a molten resin is first introduced) somewhat varies depending upon the rotating speed of the rolls, and the upper limit of the temperature is usually 230° C., preferably 210° C., more preferably 200° C., in order to prevent production of yellow-colored film, whereas the lower limit of the temperature is usually 100° C., preferably 130° C., more preferably 160° C., in order to prevent production of a film having low smoothness. The temperature of second and subsequent rolls is not particularly limited, and is usually set at the same level as the temperature of rolls between which the molten resin is first introduced, or at a little lower level than that.

The film drawn through the gap between the calender rolls has a thickness of several microns to several millimeters. The thickness of the film can be controlled by selecting calender speed, roll temperature and roll-to-roll nip distance.

The film drawn through the gap between the calender rolls is then subjected to a take-off roll, a cooling draw apparatus and a wind-up machine, and the resulting film can be used as a light-transmitting film of the invention. The thus-obtained film has a yellowing degree of preferably 2 or less, particularly preferably 1 or less. The film obtained by the process of the invention does not suffer yellowing, and hence it can appropriately be used for optical uses.

In order to improve storage stability of the recording media of the invention, it is of importance to control composition of the light-transmitting layer and not to cause change in light-transmitting property of the information recording layer or the light-transmitting layer due to various outer forces. Thus, it is preferred for the surface of the medium to have a pencil hardness of 2 H or more.

In order to improve scratch resistance of the surface, JP-A-2003-99982 describes, for example, to use a silicone-based lubricant, a fluorine-containing lubricant or a fatty acid ester-based lubricant in the outermost layer. However, this technique has the defect that, though it is effective for a force applied in a direction approximately horizontal with respect to the surface, it is insufficient for a force applied in a direction vertical with respect to the surface.

Therefore, it is necessary to raise pencil hardness of the surface in order to improve preservability of the recording media.

The pencil hardness can be determined as a hardness of a pencil which does not form a scratch on the surface under a load of 9.8N using a testing pencil prescribed in JIS-S-6006 according to the method of evaluating pencil hardness prescribed in JIS-K-5400.

As a required pencil hardness, 2 H or more is preferred, with 3 H or more being more preferred. In view of durability, the higher the pencil hardness, the more preferred. When the surface has a pencil hardness of 3 H to 4 H, preservability of the recording media is markedly improved. However, a too high hardness would increase a tendency of crazing and cracking in the step of manufacturing the recording media, thus about 3 H to about 4 H being preferred.

In order to attain such pencil hardness, it is preferred for the light-transmitting layer to have on the light-transmitting film a hard coat layer comprising a cured film formed from a curable composition containing a radiation-curable resin. Hereinafter, a film formed by coating a hard coat layer on a support of the light-transmitting film of the invention is called a hard coat film. Examples of the hard coat film to be used in the invention include the following:

(1) A hard coat film formed by coating on a support a coating composition containing a multi-functional acrylate-based monomer as a resin-forming component of the layer, and powdery inorganic filler such as alumina, silica or titanium oxide and a polymerization initiator designed for increasing hardness of the layer as described in Japanese Patent No. 1,815,116.

(2) A hard coat film described in Japanese Patent No. 1,416,240 wherein a light-polymerizable composition containing silica or alumina having been surface-treated with an alkoxysilane further contains cross-linked organic fine particles.

(3) A hard coat film described in JP-A-2000-52472 wherein the hard coat layer is constituted by two layers, with fine silica particles being added to the first layer.

(4) A hard coat film described in JP-A-2000-71392 wherein the hard coat layer is constituted by two layers, with the lower layer using a cured resin layer composed of a blend of a radical-curable resin and a cation-curable resin and the upper layer comprising a radical-curable resin alone.

(5) A hard coat film described in JP-A-2002-248619 which is formed by melt-kneading a filler and a resin, and extrusion-molding the mixture.

These hard coat films as described in the above-mentioned specifications are in some cases not enough to provide a sufficient hardness. In such cases, a desired hardness can be obtained by the following improvements in the respective film-manufacturing techniques.

(1) To increase the number of functional groups of the multi-functional alkyl ester monomer, and the amounts of inorganic fillers or initiators.

(2) To increase the amount of the inorganic filler.

(3) To increase the amount of silica in the first layer.

(4) To increase the proportion of the radical-curable resin.

(5) To increase the amount of the filler.

In the invention, it is preferred to use a hard coat film obtained by coating a hard coat layer of the following constitution on the light-transmitting film of the invention.

1. A hard coat layer formed by curing a curable composition which contains a curable resin and which provides a hard coat layer with a pencil hardness of 2 H or more.

2. A hard coat layer formed by curing a curable composition which contains a curable resin having at least one of fluorine atom and silicon atom and a polymerizable group for imparting stainproof properties and which provides a cured hard coat layer whose surface has a contact angle with water of 90 degrees or more.

3. The hard coat layer as described in 1 or 2 above, which has a surface elasticity of 4.0 GPa to 10 GPa.

4. The hard coat layer as described in any one of 1 to 3 above, wherein the thickness of the hard coat layer is 10 μm to 60 μm.

5. The hard coat layer as described in any one of 1 to 4 above, wherein the curable composition is curable by irradiation with active energy rays and contains a curable resin having a ring opening-polymerizable group and/or a curable resin having 2 or more ethylenically unsaturated groups within one molecule.

6. The hard coat layer as described in 5 above, wherein the curable resin having a ring opening-polymerizable group is a cross-linkable polymer having the repeating unit represented by the following formula (1):

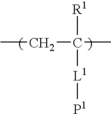

In formula (1), R¹ represents a hydrogen atom or an alkyl group containing 1 to 4 carbon atoms, P¹ represents a mono-valent, ring opening-polymerizable group, and L₁ represents a single bond or a linking group having 2 or more valencies.

7. The hard coat layer as described in 5 or 6 above, wherein the ring opening-polymerizable group is a cation-polymerizable group.

The hard coat layers and stainproof hard coat layers described in 1 to 7 above are described in more detail below.

A layer to be coated on the hard coat film of the invention (hereinafter merely referred to as “hard coat layer”) is a hard coat layer formed by curing a curable composition. Curing may be caused by active energy ray polymerization or thermal polymerization but, in view of productivity, curing with active energy rays is preferred. The surface of the hard coat layer of the invention has a pencil hardness of preferably 2 H or more, more preferably 3 H or more. The contact angle of the surface for water is preferably 90 degrees or more, more preferably 97 degrees or more in view of stainproof properties, with the upper limit being preferably 150 degrees or less, more preferably 130 degrees or less.

The contact angle of the surface of the hard coat layer for water can be adjusted within the above-mentioned range by incorporating a fluorine atom- and/or silicon atom-containing, polymerizable group-having curable resin or compound as a stainproofing agent. The polymerizable group is preferably a group which can be polymerized by irradiation with active energy rays.

As the curable resin, which contains a fluorine atom and/or silicon atom and which has a group being polymerizable with active energy rays, to be used as a stainproofing agent, known fluorine-containing curable resins or silicon-containing curable resins polymerizable with the active energy rays, or curable resins having both a fluorine atom-containing skeleton and a silicon atom-containing skeleton are used.

Further, an active energy ray-polymerizable resin having a skeleton well compatible with the curable resin mainly constituting the hard coat layer or the metal oxide particles dispersed in the resin and a skeleton having a fluorine atom and/or a silicon atom is preferred.

Fluorine or silicon is allowed to exist on the surface of the hard coat layer by curing such curable resin for forming the hard coat layer or the stainproofing layer.

Additionally, in this specification, the stainproofing layer constitutes a part of the stainproofing hard coat layer. However, for convenience of description, the stainproofing layer is in some cases described with discriminating from the hard coat layer and, even in such cases, the stainproof layer is included in the stainproof hard coat layer.

Specific examples of the above-described curable resins to be used in the hard coat layer as a stainproofing agent include monomers containing a fluorine atom or a silicon atom and polymers obtained by introducing an acryl group into copolymers, block copolymers or graft copolymers of a monomer containing a fluorine atom or a silicon atom.

Examples of the fluorine-containing monomer include hexafluoroisopropyl acrylate, heptadecafluorodecyl acrylate, and perfluoroalkyl group-having (meth)acrylates represented by perfluoroalkylsulfonamidoethyl acrylate and perfluoroalkylamidoethylacrylate.

Specific examples thereof include compounds having a polymerizable group such as acrylic compounds such as 2-perfluorooctylethyl methacrylate, 2-perfluorooctylethyl acrylate (manufactured by Nippon Mektron, Ltd.), M-3633, M-3833, R-3633 and R-3833 (manufactured by Daikin Fine Chemical Laboratories); AFC-1000, AFC-2000 and FA-16 (manufactured by Kyoeisha Chemical Co., Ltd.); and Megafac 531 (manufactured by Dainippon Ink and Chemicals Inc.)

As the fluorine-containing copolymer, there is a copolymer wherein the main chain comprises carbon atom alone and which contains a fluorine-containing vinyl monomer polymerization unit and a polymerization unit having a (meth)acryloyl group in the side chain. Specific examples thereof include the copolymers represented by the following formula (2):

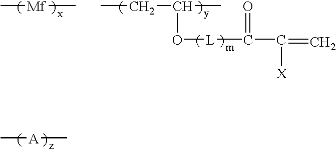

In formula (2), Mf represents a fluorine-containing vinyl monomer, L represents a linking group having 1 to 10 carbon atoms, m represents 0 or 1, X represents a hydrogen atom or a methyl group, A represents an optional polymerization unit of vinyl monomer constituted by a single component or a plurality of components, and x, y and z each represents a mol % of each constituent, with 30≦x≦60, 40≦y≦80 and 0≦z≦65.

As the fluorine-containing vinyl monomer represented by Mf in formula (2), fluoroolefins (e.g., fluoroethylene, vinylidene fluoride, tetrafluoroethylene or hexafluoropropyloene), partially or completely fluorinated alkyl ester derivatives of (meth)acrylic acid (e.g., Viscoat 6FM (trade name; manufactured by Osaka Yuki Kagaku) and M-2020 (trade name; manufactured by Daikin) perfluoroalkylsufonic acid methacrylamide and completely or partially fluorinated vinyl ethers. Of these, perfluoroolefins are preferred, with hexafluoropropylene being particularly preferred in view of solubility, transparency and availability.

The copolymers of the invention have in the side chain thereof a polymerization unit having a (meth)acryloyl group as a necessary component. Methods for introducing (meth)acryloyl group into the copolymer is not particularly limited, and examples thereof include (1) a method of synthesizing a polymer having a nucleophilic group such as a hydroxyl group or an amino group, and acting (meth)acryl chloride, (meth)acrylic anhydride or a mixed acid of (meth)acrylic acid and methanesulfonic acid on the polymer, (2) a method of acting (meth)acrylic acid on the nucleophilic group-having polymer described above in the presence of a catalyst such as sulfuric acid, (3) a method of acting a compound having both an isocyanato group and a (meth)acryloyl group such as methacryloyloxypropyl isocyanate on the nucleophilic group-having polymer described above, (4) a method of synthesizing an epoxy group-having polymer and acting thereon (meth)acryloic acid, (5) a method of acting a compound having both an epoxy group and a (emth)acryloyl group such as glycidyl methacrylate on a polymer having a carboxyl group, and (6) a method of polymerizing a vinyl monomer having a 3-chloropropionate moiety, then conducting dehydrochlorination. Of these method, it is preferred in the invention to introduce (meth)acryloyl group into a hydroxyl group-containing polymer by the method of (1) or (2).

The film strength can be improved by increasing the composition ratio of the (meth)acryloyl group-containing polymerization unit. The content of the (meth)acryloyl group-containing polymerization unit is preferably 40 to 80 mol %, more preferably 45 to 75 mol %, particularly preferably 50 to 70 mol %, though it varies depending upon the kind of the fluorine-containing vinyl monomer polymerization unit.

In the copolymers useful for the invention, a vinyl monomer represented by A in formula (2) may properly be copolymerized in addition to the fluorine-containing vinyl monomer polymerization unit and the polymerization unit having a (meth)acryloyl group in the side chain in view of various points such as solubility for a solvent, transparency, lubricating properties, and dust- and stain-proofing properties. A plurality of these vinyl monomers may be combined depending upon the purpose thereof, and are preferably introduced in a content of 0 to 65 mol %, more preferably 0 to 30 mol %, based on the copolymer.

The vinyl monomer units to be used in combination are not particularly limited, and examples thereof include olefins (e.g., ethylene, propylene, isoprene, vinyl chloride and vinylidene chloride), acrylates (e.g., methyl acrylate, ethyl acrylate, butyl acrylate, 2-ethylhexyl acrylate, 2-hydroxyethyl acrylate, glycidyl acrylate, allyl acrylate and trimethoxysilylpropyl acrylate), methacrylates (e.g., methyl methacrylate, ethyl methacrylate, butyl methacrylate, 2-ethylhexyl methacrylate, 2-hydroxyethyl methacrylate, glycidyl methacrylate, allyl methacrylate and trimethoxysilylpropyl methacrylate), styrene derivatives (e.g., styrene, p-hydroxymethylstyrene and p-methoxystyrene), vinyl ethers (e.g., methyl vinyl ether, ethyl vinyl ether, isopropyl vinyl ether, t-butyl vinyl ether, cyclohexyl vinyl ether, hydroxyethyl vinyl ether, hydroxybutyl vinyl ether, glycidyl vinyl ether and allyl vinyl ether), vinyl esters (e.g., vinyl acetate, vinyl propionate, vinyl butyrate and vinyl cinnamate), unsaturated carboxylic acids (e.g., acrylic acid, methacrylic acid, crotonic acid, maleic acid and itaconic acid), acrylamides (e.g., (N,N-dimethylacrylamide, N-tert-butyl-acrylamide and N-cyclohexylacrylamide) and methacrylamides (e.g., N,N-dimethylmethacrylamide) and acrylonitrile.

Of these, vinyl ether derivatives and vinyl ester derivatives are preferred, with vinyl ether derivatives being particularly preferred.

In formula (2), L represents a linking group having 1 to 10 carbon atoms, more preferably a linking group having 1 to 6 carbon atoms, particularly preferably a linking group having 2 to 4 carbon atoms, which may have a straight, branched or cyclic structure and may have a hetero atom-selected from among O, N and S.

Preferred examples thereof include *—(CH₂)₂—O—**, *—(CH₂)₂—NH—**, *—(CH₂)₄—O—**, *—(CH₂)₆—O—**, *—(CH₂)₂—O—(CH₂)₂—O—**, *—CONH—(CH₂)₃—O—**, *—CH₂CH(OH)CH₂—O—** and *—CH₂CH₂OCONH (CH₂)₃—O—** (* represents a linking position on the main chain side, and ** represents a linking position on the (meth)acryloyl group side). m represents 0 or 1.

In formula (2), X represents a hydrogen atom or a methyl group. In view of curing reactivity, X preferably represents a hydrogen atom.

x, y and z each represents mol % of each constituent, and 30≦x≦60, 40≦y≦80 and 0≦z≦65. The ranges are preferably 35≦x≦55, 45≦y≦75 and 0≦z≦20, particularly preferably 40≦x≦55, 50≦y≦70 and 0≦z≦10.

Examples of the silicon-containing monomer include monomers having a siloxane group obtained by reacting polydimethylsiloxane with (meth)acrylic acid. Specific examples of siloxane compounds having terminal (meth)acrylate include X-22-164A, X-22-164B, X-22-164C, X-22-2404, X-22-174D, X-22-8201 and X-22-2426 (manufactured by Shin-Etsu Chemical Co., Ltd.).

In the case of a hard coat film wherein a curable composition layer containing a compound having at least one of fluorine atom and silicon atom and having an active energy ray-polymerizable group on a curable composition layer not containing a compound having at least one of fluorine atom and silicon atom and having an active energy ray-polymerizable group, the thickness of the curable composition layer containing a compound having at least one of fluorine atom and silicon atom and having an active energy ray-polymerizable group is preferably 0.05 μm to 2 μm. If the thickness is too small, a sufficient film strength and a sufficient stainproofing effect can not be obtained, whereas, if more than 1 μm, technical significance of the multi-layer structure is reduced, thus the thickness being preferably 0.1 μm to 1 μm.

The group polymerizable with irradiation of active energy rays can be imparted by introducing a radical-polymerizable double bond of, for example, an acryl group or a cation-polymerizable group of, for example, an epoxy group. The content of the compound having a silicon atom and an active energy ray-polymerizable group contained in the curable composition is preferably 0.01 to 20% by weight, more preferably 1 to 15% by weight, based on the curable resin.

In order to obtain an excellent marring resistance of the hard coat layer, the hard coat layer has a certain degree of hardness. In view of hardness, the surface elasticity modulus of the hard coat layer is preferably about 4.0 GPa or more, more preferably 4.5 GPa or more. A hard coat layer having a surface elasticity modulus of less than 4.0 GPa fails to provide enough pencil hardness and enough marring resistance. Additionally, in terms of universal hardness, the surface elasticity modulus is preferably about 250 N/mm² or more, more preferably 300 N/mm² or more.

The surface elasticity modulus can be increased by adding inorganic fine particles. Since brittleness becomes serious by adding the inorganic fine particles too much, the upper limit of the surface elasticity modulus if 10 GPa, preferably 9.0 GPa. Therefore, The surface elasticity modulus is in a range of preferably 4.0 to 10 GPa, particularly preferably 4.5 to 9.0 GPa.

As a result of examining to obtain both a sufficient pencil hardness and a sufficient brittleness of the hard coat layer, it has been found effective to coat a hard coat agent providing an improved brittleness though providing somewhat small hardness in a large thickness.

The surface elasticity modulus is a value determined by using a micro-surface hardness meter (made by Fischer Instruments; Fischer Scope H100VP-HCU). Specifically, it is an elasticity modulus determined by using a tetragonal pyramid indenter (angle between the opposite faces at the intender foot: 136°) made of diamond, measuring the indentation depth under a proper test load within the range of not exceeding 1 μm in the indentation depth, and determining the elasticity modulus from the changes of load and displacement upon removal of the load.

It is also possible to determine the surface hardness as a universal hardness using the aforesaid micro-surface hardness meter. The universal hardness is a value obtained by measuring the indentation depth of a tetragonal pyramid indenter under a testing load, and dividing the testing load by the surface area of an impression generated under the testing load (the area being calculated based on the geometric pattern of the impression).

It is known that there is a positive correlation between the surface elasticity modulus and the universal hardness.

The thickness of the hard coat layer of the invention is preferably 10 μm or more, more preferably 20 μm or more. In case where the thickness of the hard coat layer is increased too much, it becomes difficult to bend the resulting film, and cracks are liable to be formed upon bending. Thus, the thickness of the hard coat layer is preferably 60 μm or less, more preferably 50 μm or less. Therefore, the thickness of the hard coat layer is preferably 10 to 60 μm, more preferably 20 to 50 μm.

The hard coat layer may be constituted by a single layer or a plurality of layers, but a single layer is preferred because of simple and easy operation of production steps. The single layer here means a hard coat layer formed by curing one and the same curable composition, and may be formed by coating a composition plural times as long as the composition shows the same formulation after coating and drying, followed by curing. On the other hand, a hard coat layer composed of a plurality of layers means a layer formed by coating and curing a plurality of curable compositions different from each other in formulation.

The hard coat layer of the invention is formed by coating a curable composition which can be cured by irradiation with active energy rays, then curing the composition by irradiating with active energy rays. The cure shrinkage of the curable composition by irradiation with active energy rays is 0 to 15%, preferably 0 to 13%, more preferably 0 to 11%.

The cure shrinkage is a value determined by measuring density of the curable composition before irradiation with the active energy rays such as UV rays and density of the curable composition after irradiation with the active energy rays, and calculating according to numerical expression A using the densities. Additionally, the density was measured by means of MULTIVOLUME PYCNOMETER (manufactured by Micrometric Co.) at 25° C.
Volume shrinkage={1−(density before curing/density after during)}×100 Numerical Expression A:

The curable composition for forming the hard coat layer contains as a major component a curable resin which is different from the curable resin functioning as a stainproofing agent and which is curable with active energy rays or heat. The curable composition for forming the hard coat layer (hereinafter also merely referred to as “curable composition”) preferably contains as the curable resin a curable resin having a ring opening-polymerizable group and/or a curable resin having a molecular which has 2 or more (more preferably 3 or more) ethylenically unsaturated groups. It is more preferred to contain both of the curable resins, whereby the surface hardness of the hard coat layer is increased so much that there can be obtained a hard coat film having excellent marring resistance. At the same time, the volume shrinkage falls within the above-described range, curling after curing is reduced, and cracking upon various handlings is difficult to take place. Further, by adjusting the thickness of the hard coat layer to a definite thickness, the above-described effects become more remarkable.

The curable resin which contains a ring opening-polymerizable group and which is preferably used in the invention is described below.

The curable resins containing a ring opening-polymerizable group are a curable resin having a cyclic structure which undergo ring-opening polymerization by the action of cation, anion or radical. Of them, a hetero ring group-containing curable resin is preferred. Examples of such curable resin include epoxy derivatives, oxetane derivatives, tetrahydrofuran derivatives, cyclic lactone derivatives, cyclic carbonate derivatives and cyclic iminoether derivatives such as oxazoline derivatives, with epoxy derivatives, oxetane derivatives and oxazoline derivatives being particularly preferred.

In the invention, the curable resin having the ring opening-poloymerizable group preferably has 2 or more, more preferably 3 or more, ring opening-polymerizable groups within the molecule. Also, in the invention, two kinds or more of the curable resins having the ring opening-polymerizable group may be used in combination thereof. In this case, a curable resin having one ring opening-polymerizable group within the molecule and a curable resin having two or more ring opening-polymerizable groups within the molecule may be combined with each other, or only curable resins having two or more ring opening-polymerizable groups within the molecule may be used in combination of two or more thereof.

The curable resin having the ring opening-polymerizable group is not particularly limited as long as it has the above-mentioned cyclic structure. Preferred examples of the curable resin include monofunctional glycidyl ethers, monofunctional alicyclic epoxy derivatives, bifunctional alicyclic epoxy derivatives, diglycidyl ethers (e.g., ethylene glycol diglycidyl ether and bisphenol A diglycidyl ether), glycidyl ethers having three or more functional groups (e.g., trimethylolethane triglycidyl ether, trimethylolpropane triglycidyl ether, glycerol triglycidyl ether and tris(glycidyloxyethyl) isocyanurate), glycidyl ethers having 4 or more functional groups (e.g., sorbitol tetraglycidyl ether, pentaerythritol tetraglycidyl ether, cresol novolak resin polyglycidyl ether and phenol novolak resin polyglycidyl ether), alicyclic epoxy derivatives (Ceroxide 2021P, Ceroxide 2081, Epolead GT-301, Epolead GT-401 (manufactured by Daicel Chemical Industries, Ltd.), EHPE (manufactured by Daicel Chemical Industries, Ltd.) and phenol novolak resin polycyclohexylepoxymethyl ether), and oxetanes (OX-SQ and PNOX-1009 made by Toagosei Co., Ltd.). However, the invention is not limited only to them.

In the invention, it is particularly preferred for the curable resin having the ring opening-poloymerizable group to contain a crosslinkable polymer having the repeating unit represented by formula (1). The cross-linkable polymer is described below.

In formula (1), R¹ represents a hydrogen atom or an alkyl group containing 1 to 4 carbon atoms, preferably a hydrogen atom or a methyl group. L¹ represents a single bond or a linking group having a valence of 2 or more, preferably a single bond, —O—, an alkylene group and *—COO—, *—CONH—, *—OCO— or *—NHCO— (* representing the position which links to the main chain). P¹ represents a monovalent ring opening-polymerizable group or a monovalent group having a ring opening-polymerizable group. Preferred examples of P¹ include a monovalent group having an epoxy ring, an oxetane ring, a tetrahydrofuran ring, a lactone ring, a carbonate ring or an iminoether ring such as an oxazoline ring. Of these, a monovalent group having an epoxy ring, an oxetane ring or an oxazoline ring is particularly preferred.

In the invention, it is preferred to synthesize the crosslinkable polymer containing the repeating unit represented by formula (1) by polymerizing the corresponding monomer. As the polymerization reaction to be employed here, radical polymerization is simplest and preferred.

Specific preferred examples of the repeating unit represented by formula (1) are illustrated below which, however, do not limit the invention.

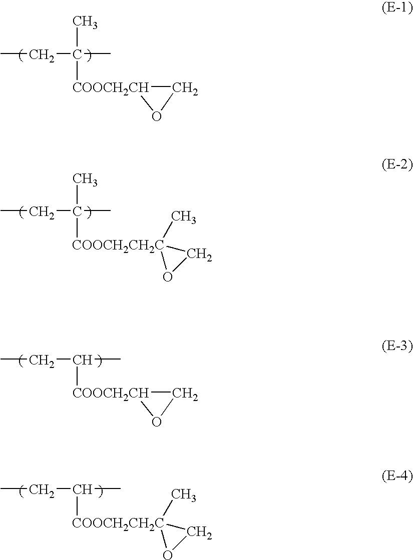

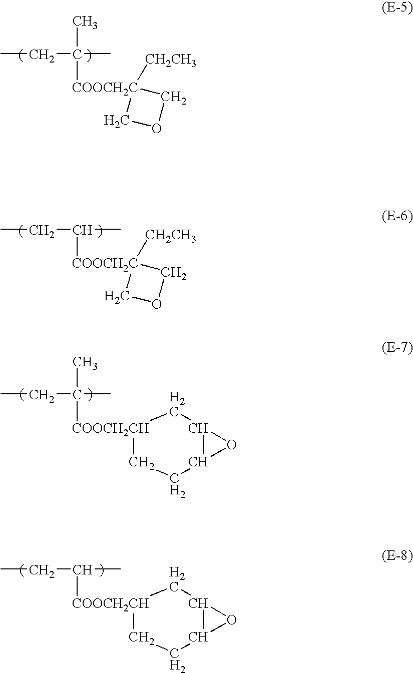

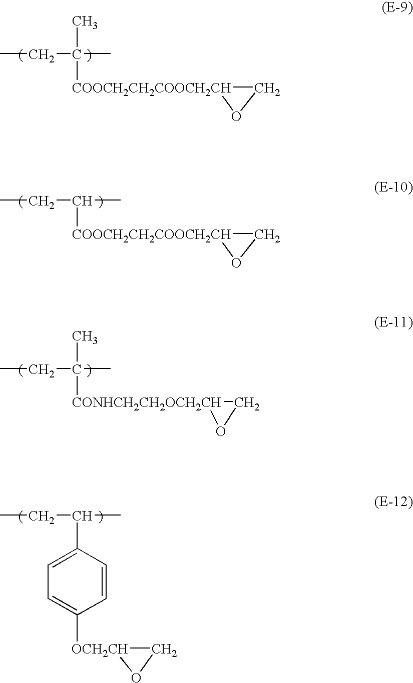

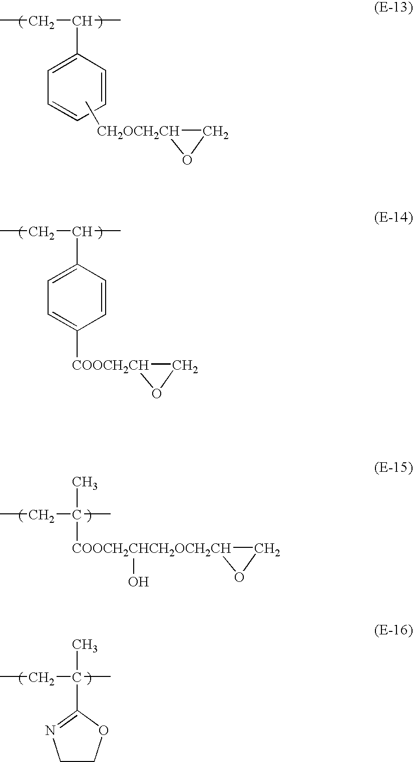

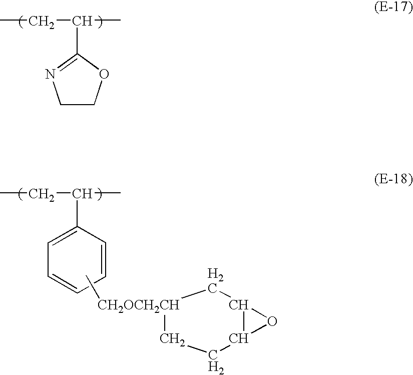

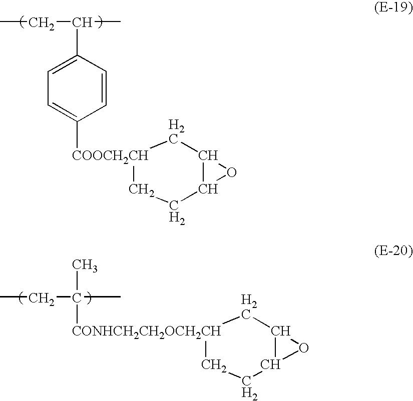

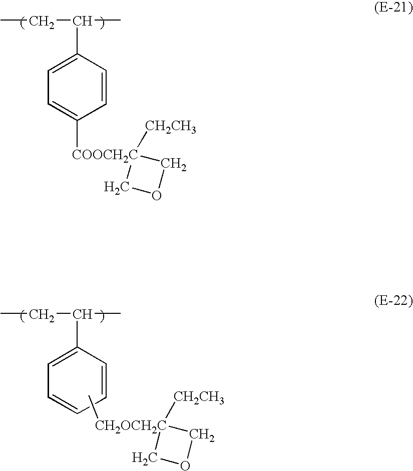

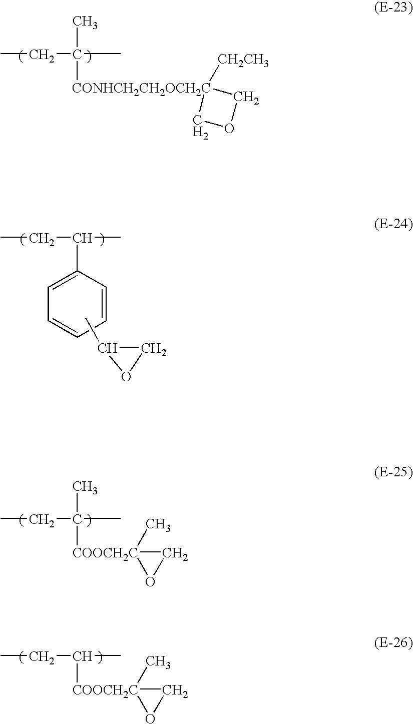

In the invention, the crosslinkable polymer containing the repeating unit represented by formula (1) may be a copolymer constituted by a plurality of repeating units represented by formula (1), or may be a copolymer containing other repeating unit than that represented by formula (1) (for example, a repeating unit not containing the ring opening-polymerizable group) In particular, in the case of controlling Tg or hydrophilicity or hydrophobicity of the crosslinkable polymer, or for the purpose of controlling the content of the ring opening-polymerizable group in the cross-linkable polymer, the technique of using the copolymer having other repeating units than that represented by formula (1) is suitable. Introduction of the repeating unit other than that represented by formula (1) is preferably conducted by copolymerizing the corresponding monomer.

In the case of introducing other repeating unit than that represented by formula (1) by copolymerizing a corresponding vinyl monomer, examples of the monomer to be preferably used include esters derived from acrylic acid or α-alkylacrylic acid (e.g., methacrylic acid) (e.g., methyl acrylate, ethyl acrylate, hydroxyethyl acrylate, n-propyl acrylate, i-propyl acrylate, 2-hydroxypropyl acrylate, 2-methyl-2-nitropropyl acrylate, n-butyl acrylate, i-butyl acrylate, t-butyl acrylate, t-pentyl acrylate, 2-methoxyethyl acrylate, 2-ethoxyethyl acrylate, 2-methoxymethoxyethyl acrylate, 2,2,2-trifluoroethyl acrylate, 2,2-dimethylbutyl acrylate, 3-methoxybutyl acrylate, ethylcarbitol acrylate, phenoxyethyl acrylate, n-pentyl acrylate, 3-pentyl acrylate, octafluoropentyl acrylate, n-hexyl acrylate, cyclohexyl acrylate, cyclopentyl acrylate, cetyl acrylate, benzyl acrylate, n-octyl acrylate, 2-ethylhexyl acrylate, 4-methyl-2-propylpentyl acrylate, heptadecafluorodecyl acrylate, n-octadecyl acrylate, methyl methacrylate, 2,2,2-trifluoroethyl methacrylate, tetrafluoropropyl methacrylate, hexafluoropropyl methacrylate, hydroxyethyl methacrylate, 2-hydroxypropyl methacrylate, n-butyl methacrylate, i-butyl methacrylate, sec-butyl methacrylate, n-octyl methacrylate, 2-ethylhexyl methacrylate, 2-methoxyethyl methacrylate, 2-ethoxyethyl methacrylate, benzyl methacrylate, heptadecafluorodecyl methacryolate, n-octadecyl methacrylate, 2-isobornyl methacryolate, 2-norbornylmethyl methacrylate, 5-norbornen-2-ylmethyl methacrylate, 3-methyl-2-norbornylmethyl methacrylate and dimethylaminoethyl methacrylate), amides derived from acrylic acid or α-alkylacrylic acid (e.g., methacrylic acid) (e.g., N-i-propylacrylamide, N-n-butylacrylamide, N-t-butylacrylamide, N,N-dimethylacrylamide, N-methylmethacrylamide, acrylamide, 2-acrylamido-2-methylpropanesulfonic acid, acrylamidopropyltrimethylammonium chloride, methacrylamide, diacetoneacrylamide, acryloylmorpholine, N-methylolacrylamide and N-methylolmethacrylamide), acrylic acid or α-alkylacrylic acid (e.g., acrylic acid, methacrylic acid and itaconic acid), vinyl esters (e.g., vinyl acetate), esters derived from maleic acid or fumaric acid (e.g., dimethyl maleate, dibutyl maleate and dieithyl fumarate), maleimides (e.g., N-phenylmaleimide), maleic acid, fumaric acid, sodium salt of p-styrenesulfonic acid, acrylonitrile, methacrylonitrile, dienes (e.g., butadiene, cyclopentadiene and isoprene), aromatic vinyl compounds (e.g., styrene, p-chlorostyrene, t-butylstyrene, α-methylstyrene and sodium styrenesulfonate), N-vinylpyrrolidone, N-vinyloxazolidone, N-vinylsuccinimide, N-vinylformamide, N-Vinyl-N-methylformamide, N-vinylacetamide, N-vinyl-N-methylacetamide, 1-vinylimidazole, 4-vinylpyridine, vinylsulfonic acid, sodium vinylsulfonate, sodium allylsulfonate, sodium methallylsulfonate, vinylidene chloride, vinyl alkyl ethers (e.g., methyl vinyl ether), ethylene, propylene, 1-butene and isobutene.

These vinyl monomers may be used in combination of two or more thereof. As other vinyl monomers, those described in Research Disclosure No. 19551 (July 1980) may be used.

Of these, esters and amides derived from acrylic acid or methacrylic acid and aromatic vinyl compounds are particularly preferably used.

As other repeating unit than that represented by formula (1), a repeating unit having other reactive group than the ring opening-polymerizable group can be introduced. Particularly in the case of enhancing hardness of the hard coat layer or improving adhesion between the hard coat layer and other functional layer (if provided on the hard coat layer), the technique of using a copolymer containing other reactive group than the ring opening-polymerizable group is appropriate. Introduction of the repeating unit having other reactive group than the ring opening-polymerizable group is preferably conducted by copolymerizing the corresponding vinyl monomer (hereinafter referred to as “reactive monomer”).

Specific examples of the reactive monomer are illustrated below which, however, do not limit the invention.

Examples thereof include hydroxyl group-containing vinyl monomers (e.g., hydroxyethyl acrylate, hydroxyethyl methacrylate, allyl alcohol, hydroxypropyl acrylate and hydroxypropyl methacrylate), isocyanato group-containing vinyl monomers (e.g., isocyanatoethyl acrylate and isocyanatoethyl methacrylate), N-methylol group-containing vinyl monomers (e.g., N-methylolacrylamide and N-methylolmethacrylamide), carboxyl group-containing vinyl monomers (e.g., acrylic acid, methacrylic acid, itaconic acid, carboxyethyl acrylate and vinyl benzoate), alkyl halide-containing vinyl monomers (e.g., chloromethylstyrene and 2-hydroxy-3-chloropropyl methacrylate), acid anhydride-containing vinyl monomers (e.g., maleic anhydride), formyl group-containing vinyl monomers (e.g., acrolein and methacrolein), sulfinic acid group-containing vinyl monomers (e.g., potassium styrenesulfinate), active methylene-containing vinyl monomers (e.g., acetoacetoxyethyl methacrylate), acid chloride-containing monomers (e.g., acrylic acid chloride and methacrylic acid chloride), amino group-containing monomers (e.g., allylamine), and alkoxysilyl goup-containing monomers (e.g., methacryloyloxypropyltrimethoxysilane and acryloyloxypropyltrimethoxysilane).

In the invention, the proportion of the repeating unit represented by formula (1) in the cross-linkable polymer containing the repeating unit represented by formula (1) is 1% by weight to 100% by weight, preferably 30% by weight to 100% by weight, particularly preferably 50% by weight to 100% by weight.

The cross-linkable polymer containing the repeating unit represented by formula (1) has a number-average molecular weight (measured by gel permeation chromatography in terms of polyethylene glycol) is preferably in a range of from 1,000 to 1,000,000, more preferably from 3,000 to 200,000, most preferably from 5,000 to 100,000.

Preferred examples of the cross-linkable polymer containing the repeating unit represented by formula (1) are shown in Table 1 which, however, do not limit the invention. Additionally, the repeating units represented by formula (1) and illustrated hereinbefore are shown by the numbers given hereinbefore, the repeating units derived from copolymerizable monomers are shown by their names, and copolymerization composition ratios are shown in % by weight.

TABLE 1

| | | Copolymerization |
|---|---|---|
| | | formulation ratio |
| | Constitution of repeating unit | (% by weight) |
| K-1 | E-1 | 100 |
| K-2 | E-1/n-butyl methacrylate | 60/40 |
| K-3 | E-1/styrene | 80/20 |
| K-4 | E-1/N-t-butylacrylamide | 80/20 |
| K-5 | E-1/butyl methacrylate/hydroxyethyl | 40/50/10 |
| | methacrylate | |
| K-6 | E-1/methacryloyloxypropyltrimethoxysilane | 70/30 |
| K-7 | E-1/E-5 | 50/50 |
| K-8 | E-1/E-7 | 50/50 |
| K-9 | E-1/E-11 | 80/20 |
| K-10 | E-5/methyl methacrylate | 70/30 |
| K-11 | E-7 | 100 |
| K-12 | E-7/E-17 | 60/40 |
| K-13 | E-13 | 100 |
| K-14 | E-14/E-1 | 67/33 |
| K-15 | E-17 | 100 |
| K-16 | E-18/chloromethylstyrene | 90/10 |
| K-17 | E-19/N-vinylformamide | 66/34 |
| K-18 | E-21/E-3 | 30/70 |
| K-19 | E-22/N-phenylmaleimide | 50/50 |
| K-20 | E-3/vinyl acetate | 90/10 |
| K-21 | E-2 | 100 |

As has been described hereinbefore, the curable composition which is cured by irradiation with active energy rays to form the hard coat layer preferably contains both the curable resin containing the ring opening-curable group and the curable resin having a molecular which has 2 or more ethylenically unsaturated groups (that is, the curable resin having two or more ethylenically unsaturated groups within the molecule).

The curable resins containing two or more ethylenically unsaturated groups within the molecule are described in detail below.

Preferred examples of the ethylenically unsaturated group include an acryloyl group, a methacryloyl group, a styryl group and a vinyl ether group, with an acryloyl group being particularly preferred.

Additionally, a curable resin (monomer or oligomer) containing one or two ethylenically unsaturated groups may be used together with the curable resin containing two or more ethylenically unsaturated groups within the molecule.

Further, a multi-functional acrylate monomer having 2 to 6 acrylate groups within the molecule and an oligomer having several acrylate groups within the molecule and having a several-hundred to several-thousand molecular weight, called urethane acrylate, polyester acrylate or epoxy acrylate, may preferably be used as the curable composition of the invention.

Specific examples of the curable resin having 2 or more acryl groups within the molecule include polyol polyacrylates such as ethylene glycol diacrylate, 1,6-hexanediol diacrylate, bisphenol A diacrylate, trimethylolpropane triacrylate, ditrimethylolpropane tetraacrylate, pentaerythritol triacrylate, pentaerythritol tetraacrylate, dipentaerythritol pentaacrylate and dipentaerythritol hexaacrylate; and urethane acrylate obtained by the reaction between poloyisocyanate and a hydroxyl group-containing acrylate such as hydroxyethyl acrylate. Curable resins having 2 or more acryl groups within the molecule are more preferred.

Further, in the invention, a crosslinkable polymer having a repeating unit represented by formula (3) is also used preferably as the curable resin having two or more ethylenically unsaturated groups within the molecule. The crosslinkable polymer having the repeating unit represented by formula (3) is explained specifically below.
Formula (3):

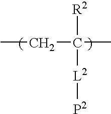

In formula (3), R² represents a hydrogen atom or an alkyl group of from 1 to 4 carbon atoms, with a hydrogen atom or a methyl group being preferred.

P² represents a monovalent ethylenically unsaturated group or a monovalent group having an ethylenically unsaturated group.

L² represents a single bond or a bivalent or higher valent bonding group, preferably, a single bond, —O—, alkylene group, arylene group and *—COO—, *—CONH—, *—OCO—, or *—NHCO— bonded to the main chain on the side of *.

Preferred P² includes, for example, an acryloyl group, methacryloyl group, styryl group or a monovalent group containing any one of those groups, acryloyl group or a monovalent group containing the same being most preferred.

The crosslinkable polymer containing the repeating unit represented by formula (3) may be synthesized by (i) a method of direct introduction by polymerizing corresponding monomers, or (ii) a method of introduction of an ethylenically unsaturated group, by a polymerization reaction, to a polymer obtained by polymerizing monomers having an optional functional group. The synthesis may also be conducted by the methods (i) and (ii) in combination. The polymerization reaction can include, for example, radical polymerization, cation polymerization and anion polymerization.

In a case of adopting the method (i), synthesis can be conducted by utilizing the difference of polymerizability between the ethylenically unsaturated group consumed by the polymerization reaction and the ethylenically unsaturated group remained in the crosslinkable polymer. For example, in a case where P² of formula (3) is an acryloyl group, methacryloyl group or a monovalent group containing ether of them, the crosslinkable polymer of the invention can be obtained by the method (i) by adopting cation polymerization for the polymerization reaction. On the other hand, in a case where P² is a styryl group or a monovalent group containing a styryl group, since gelation tends to be proceeded by any of the methods of radical polymerization, cation polymerization and anion polymerization, the crosslinkable polymer of formula (3) is usually synthesized by the method (ii) described above.

As described above, (ii) the method of utilizing the polymerization reaction is useful since a crosslinkable polymer irrespective of the kind of the ethylenically unsaturated can be obtained group introduced in formula, (3).

The polymerization reaction includes (I) a method, for example, of forming a polymer containing a functional group formed from an ethylenically unsaturated group into a precursor such as splitting of hydrogen chloride from 2-chloroethyl group and then inducing it to an ethylenically unsaturated group by functional group conversion (splitting reaction, oxidizing reaction and reducing reaction, etc), and (II) a method of forming a polymer containing an optional functional group and then reacting a reactive monomer having both of a functional group capable of proceeding a bond forming reaction with the functional group in the polymer to form a covalent bond and an ethylenically unsaturated group. The methods (I) and (II) can be combined.

For the bond forming reaction referred to herein, a covalent bond forming reaction, among the bond forming reactions generally used in the field of organic synthesis, can be used with no particular reaction. On the other hand, since the ethylenically unsaturated group contained in the crosslinkable polymer is sometimes thermally polymerized and gelled during reaction, those preceding the reaction at a temperature as low as possible (preferably, 60° C. or lower and, particularly preferably, room temperature or lower) are preferred. Further, a catalyst may also be used with an aim of promoting the progress of the reaction and a polymerization inhibitor may also be used with an aim of suppressing gelation.

Examples for the combinations of the functional groups that precede the preferred polymer bond forming reaction are mentioned below but are not restricted to them.

A combination of functional groups for proceeding the reaction under heating or at a room temperature can include the followings:

(i) to a hydroxyl group, an epoxy group, isocyanate group, N-methylol group, carboxyl group, alkylhalide, acid anhydride, acid chloride, active ester group (for example, sulfate ester), formyl group, or acetal group,

(ii) to an isocyanate group, a hydroxyl group, mercapto group, amino group, carboxyl group, or N-methylol group,

(iii) to a carboxyl group, an epoxy group, isocyanate group, amino group, or N-methylol group,

(iv) to an N-methylol group, an isocyanate group, N-methylol group, carboxyl group, amino group, or hydroxyl group,

(v) to an epoxy group, a hydroxyl group, amino group, mercapto group, carboxyl group, or N-methylol group,

(vi) to a vinyl sulfonic group, a sulfinic acid group or amino group,

(vii) to a formyl group, a hydroxyl group, mercapto group, or active methylene group,

(viii) to mercapto group, a formyl group, vinyl group (allyl group, acrylic group, etc.), epoxy group, isocyanate group, N-methylol group, carboxyl group, alkylhalide, acid anhydride, acid chloride, or active ester group (for example, sulfate ester) and

(ix) to an amino group, a formyl group, vinyl group (allyl group, acryl group, etc.), epoxy group, isocyanate group, N-methylol group, carboxyl group, alkylhalide, acid anhydride, acid chloride, or active ester group (for example, sulfate, ester).

Preferred examples of the reactive monomer are shown below, but the invention is not restricted to them.

They include, for example, a hydroxyl containing vinyl monomer (for example, hydroxyethyl acrylate, hydroxyethyl methacrylate, allyl alcohol, hydroxypropyl acrylate, hydroxypropyl methacrylate, etc), isocyanate-containing vinyl monomer (for example, isocyanate ethylacrylate, isocyanate ethylmethacrylate, etc), N-methylol-containing vinyl monomer (for example, N-methylol acrylamide, N-methylol methacrylamide, etc.), epoxy-containing vinyl monomer (for example, glycidyl acrylate, glycidyl methacrylate, allylglycidyl ether, CYCLOMER-M1000, A200 (manufactured by Daicel Chemical Industries, Ltd.), carboxyl-containing vinyl monomer (for example, acrylic acid, methacrylic acid, itaconic acid, carboxyethyl acrylate and vinyl benzoate), alkyl halide-containing vinyl monomer (for example, chloromethyl styrene and 2-hydroxy-3-chloropropyl methacrylate), acid anhydride-containing vinyl monomer (for example, maleic acid anhydride), formyl-containing vinyl monomer (for example, acrolein and methacrolein), sulfinic acid-containing vinyl monomer (for example, potassium styrene sulfinate), active methylene-containing vinyl monomer (for example, acetoacethoxy ethyl methacrylate), vinyl-containing vinyl monomer (for example, allylmethacrylate and allylacrylate), acid chloride-containing monomer (for example, acrylic acid chloride and methacrylic acid chloride). and amino-containing monomer (for example, allylamine).

The polymer containing an optional functional group as described in (II) above can be obtained by conducting polymerization of reactive monomers having both of a reactive functional group and an ethylenically unsaturated group. Further, the polymer can also be obtained by conducting polymerization of a less reactive precursor monomer such as a polyvinyl alcohol obtained by modifying polyvinyl acetate followed by conversion of functional group.

As the polymerization method in the cases described above, radical polymerization is most preferred being simple and convenient.

Preferred examples of the repeating units represented by the general formula (3) are shown below, but the present invention is not restricted to them.

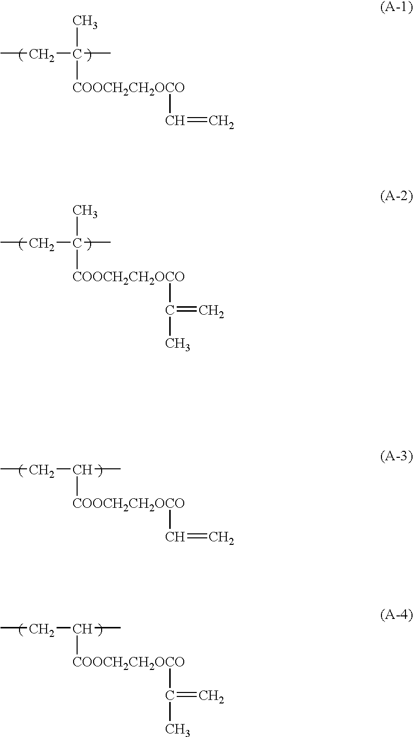

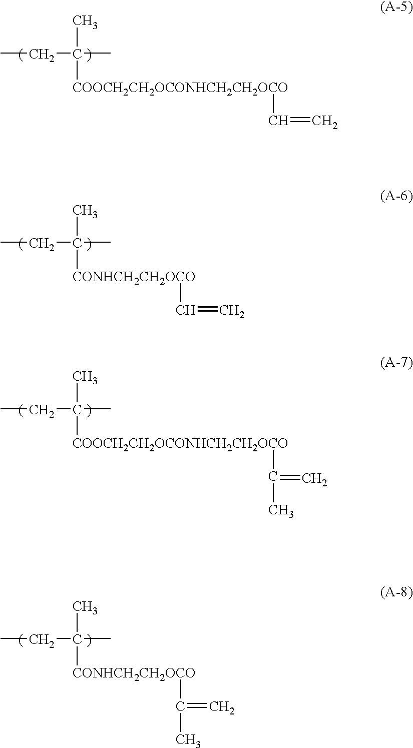

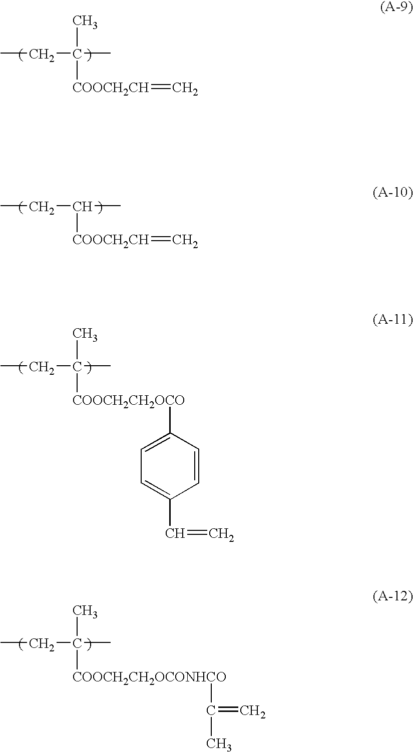

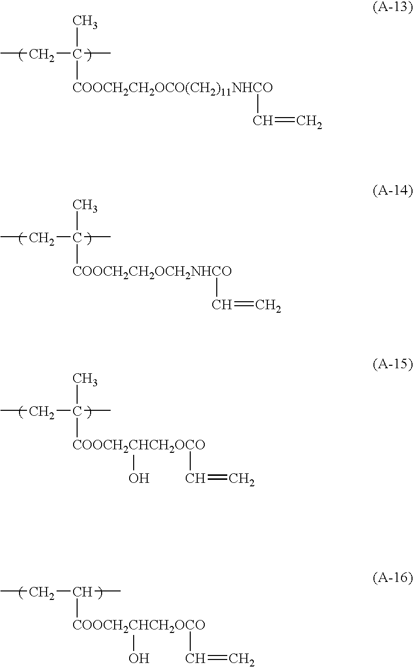

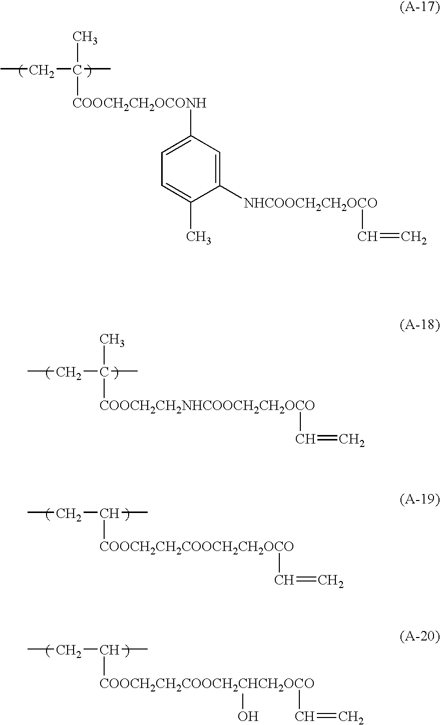

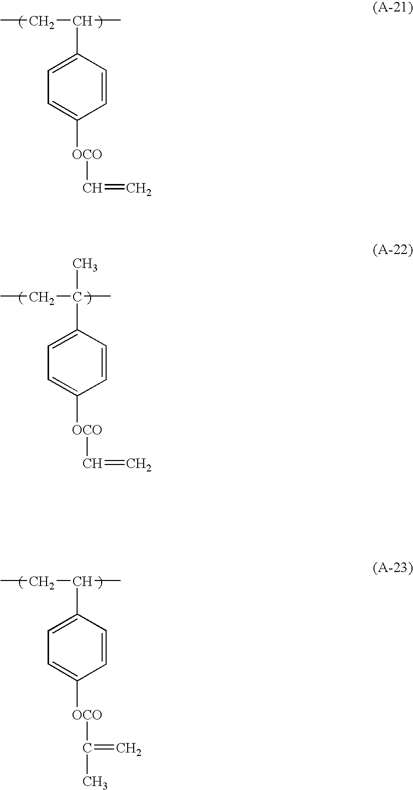

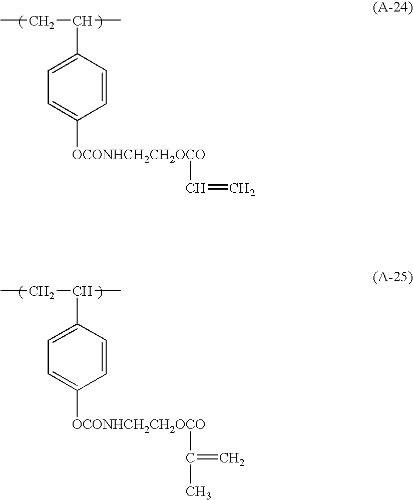

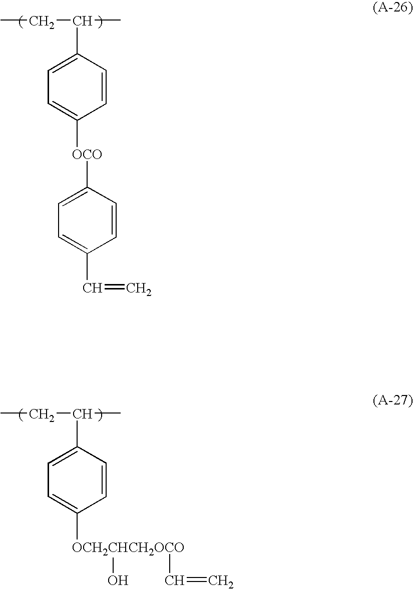

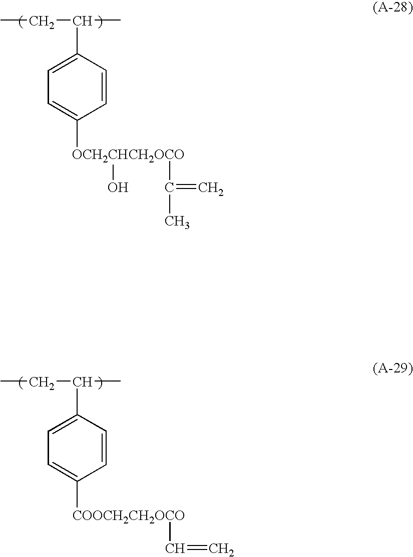

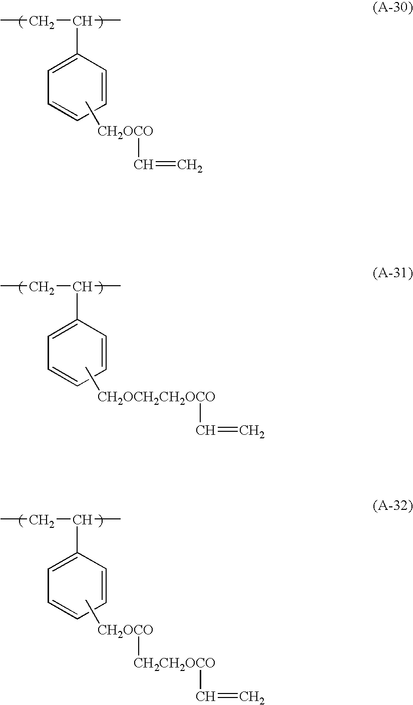

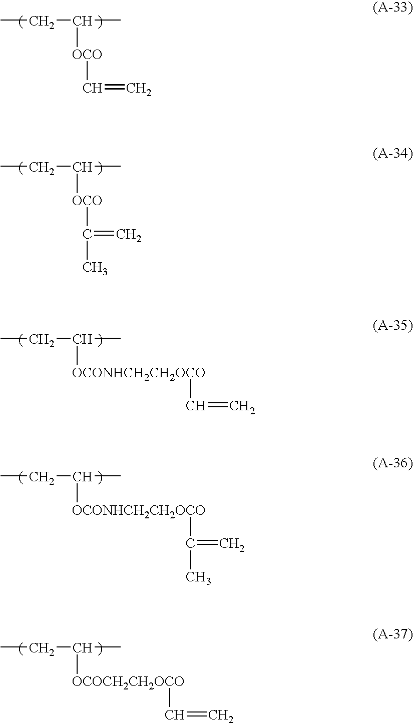

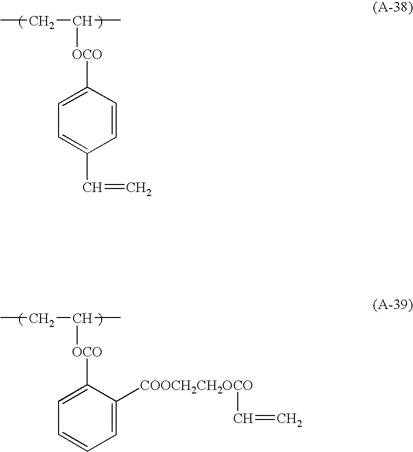

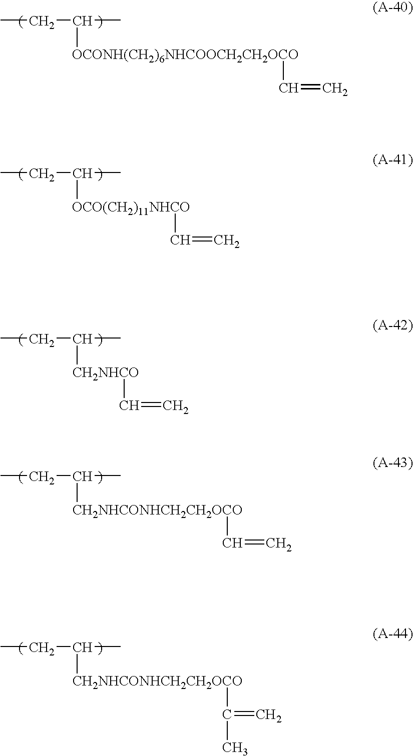

In the invention, the crosslinkable polymer containing the repeating unit represented by formula (3) may be a copolymer constituted with the plurality of repeating units represented by formula (3), or may be a copolymer containing other repeating unit than that represented by formula (3) (for example, repeating unit not containing ethylenically unsaturated group). Particularly, a method of forming a copolymer containing other repeating unit than that represented by formula (3) in a case of intending to control Tg or hydrophilicity or hydrophobicity of the crosslinkable polymer or with an aim of controlling the content of ethylenically unsaturated groups in the crosslinkable polymer is preferred. For the method of introducing other repeating unit than tht represented by formula (3), (a) a method of direct introduction by copolymerizing corresponding monomers may be used, or (b) a method of polymerizing precursor monomers capable of being converted into a functional group and introduction by polymeric reaction may also be used. Further, they can be introduced by the methods (a) and (b) in combination.

In a case of introducing other repeating unit than that represented by formula (3) by polymerization of corresponding vinyl monomers by the method (a), the monomers used preferably include monomers identical with those mentioned as used preferably in a case of introducing other repeating unit than that represented by formula (1) by polymerization of corresponding vinyl monomers in the description for formula (1) above. Two or more of such vinyl monomers may be used in combination. As other vinyl monomers than described above, those described in Research Disclosure No. 19551 (July 1980) can be used. Among them, esters and amides derived from acrylic acid or methacrylic acid, and aromatic vinyl compounds are used particularly preferably.

Further, in a case of introducing the repeating unit represented by formula (3) by polymeric reaction and not completing the reaction as described in (ii) above, this forms a copolymer having repeating units containing functional groups formed from ethylenically unsaturated group as precursors or reactive groups, and they can be used in the invention with no particular restriction.

Most of the repeating units not containing the ethylenically unsaturated groups derived from the vinyl monomers described above can be introduced by (b) polymerizing precursor monomers which can be converted into functional groups and by way of the polymeric reaction. On the other hand, the crosslinkable polymer containing repeating units represented by formula (3) in the invention may also contain other repeating units than the general formula (3) which can be introduced only by the polymeric reaction. Typical examples can include polyvinyl alcohols obtained by modifying vinyl acetate and polyvinyl butyral obtained by modification of polyvinyl acetate and polyvinyl butyral obtained by acetalizing reaction of polyvinyl alcohol. Specific examples of the repeating units are shown below but the invention is not restricted to them.

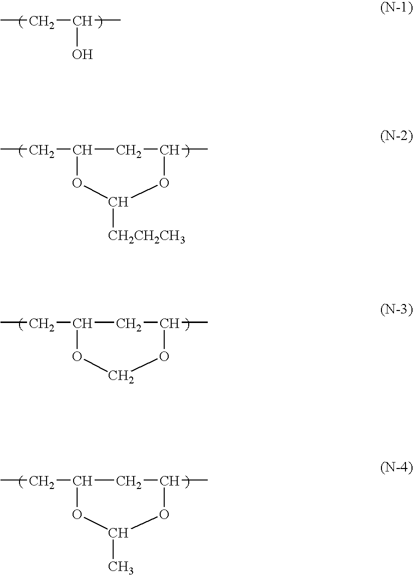

In the crosslinkable polymer containing the repeating unit represented by formula (3) in the invention, the content ratio of the repeating unit represented by the formula (3) is 1% by weight to 100% by weight, preferably, 30% by weight to 100% by weight and, particularly preferably, 50% by weight to 100% by weight.

A number-average molecular weight of the crosslinkable polymer containing the repeating unit represented by formula (3) (measured by gel permeation chromatography in terms of polyethylene glycol) is within a range of, preferably, from 1,000 to 1,000,000, further preferably, from 3,000 to 200,000. It is most preferably from 5,000 to 100,000.

Preferred examples of the crosslinkable polymer containing the repeating unit represented by formula (3) are to be shown in Table 2 but invention is not limited to them. The repeating unit represented by formula (3) and the repeating unit such as of polyvinyl alcohol previously referred to by specific examples are represented by the number of specific examples described above, while the repeating unit derived from the copolymerizable monomers are described by the name of monomers, and the copolymerization compositional ratio is attached as % by weight.

TABLE 2

| | | Copolymerization |
|---|---|---|
| | | formulation ratio |
| | Constitution of repeating unit | (% by weight) |
| P-1 | A-1 | 100 |
| P-2 | A-1/n-butyl methacrylate | 60/40 |
| P-3 | A-1/styrene | 80/20 |
| P-4 | A-1/N-t-butylacrylamide | 80/20 |
| P-5 | A-1/butyl methacrylate/hydroxyethyl | 38/50/12 |
| | methacrylate | |
| P-6 | A-1/A-7/hydroxyethyl methacrylate | 20/67/13 |
| P-7 | A-1/A-9 | 80/20 |
| P-8 | A-1/A-11 | 50/50 |
| P-9 | A-6 | 100 |
| P-10 | A-13 | 100 |
| P-11 | A-14/hydroxymethyl methacrylate | 33/67 |
| P-12 | A-15/methacrylic acid | 87/13 |
| P-13 | A-20/carboxyethyl acrylate | 67/33 |
| P-14 | A-21 | 100 |
| P-15 | A-21/N-vinylformamide | 90/10 |
| P-16 | A-25/4-hydroxystyrene | 66/34 |
| P-17 | A-30/chloromethylstyrene/N-phenyl maleimide | 23/27/50 |
| P-18 | A-33/N-1/vinyl acetate | 88/11/1 |
| P-19 | A-37/N-1/vinyl acetate | 93/6/1 |
| P-20 | A-38/N-1/N-2/vinyl acetate | 22/8/69/1 |
| P-21 | A-40/N-1/vinyl acetate | 77/22/1 |

The curable resin containing the ring-opening polymerizable group that can be used in the invention also includes polymers containing both of the repeating units represented by formulae (1) and (3). Preferred repeating unit represented by formula (1) or (3) in this case are identical with those described above. Further, it may be a copolymer containing the other repeating unit than that represented by formula (1) or (3), or a copolymer containing repeating units having other reactive groups than the ethylenically unsaturated group and the ring-opening polymerizable group.

The proportion of the repeating unit represented by formula (1) contained in the crosslinkable polymer containing both of the repeating units represented by formulae (1) and (3) is 1% by weight to 99% by weight, preferably, 20% by weight to 80% by weight, particularly, 30% by weight and 70% by weight. The proportion of the repeating unit represented by formula (3) contained therein is 1% by weight and 99% by weight, preferably, 20% by weight to 80% by weight, particularly preferably, 30% by weight to 70% by weight.

The weight-average molecular weight of the crosslinkable polymer containing both repeating units represented by formulae (1) and (3) (measured by gel permeation chromatography in terms of polyethylene glycol) is within a range of, preferably, from 1,000 to 1,000,000 and, more preferably, from 3,000 to 200,000. It is, most preferably, from 5,000 to 100,000.

Table 3 shows preferred examples of the crosslinkable polymers containing both of the repeating units represented by formulae (1) and (3) but the invention is not limited to them. The repeating unit represented by formula (1) or (3) and the repeating unit such as of polyvinyl alcohol mentioned as specific examples described above are represented by the numbers of the specific examples described previously, and the repeating units derived from the copolymerizable monomers are described by the name of monomer, and the copolymer compositional ratio was attached as % by weight.

TABLE 3

| | | Copolymerization |
|---|---|---|
| | | formulation ratio |
| | Constitution of repeating unit | (% by weight) |
| C-1 | A-1/E-1 | 70/30 |
| C-2 | A-1/E-1/n-butylmethacrylate | 60/30/10 |
| C-3 | A-1/E-1/styrene | 40/40/20 |
| C-4 | A-1/E-4/N-t-butylacrylamide | 50/30/20 |
| C-5 | A-1/E-5/E-7 | 40/40/20 |
| C-6 | A-1/A-7/hydroxyethyl methacrylate/E-1 | 30/27/13/30 |
| C-7 | A-1/A-9/E-12 | 60/10/30 |
| C-8 | A-1/A-11/E-7 | 30/50/20 |
| C-9 | A-6/E-5 | 40/60 |
| C-10 | A-15/E-1 | 53/47 |
| C-11 | A-21/E-1 | 35/65 |
| C-12 | A-1/E-7/N-vinylformamide | 60/30/10 |
| C-13 | A-25/E-19 | 60/40 |
| C-14 | A-30/E-14/N-phenylmaleimide | 60/30/10 |
| C-15 | A-33/E-12/N-1/vinylacetate | 68/20/11/1 |
| C-16 | A-3/A-9/E-12 | 40/30/30 |
| C-17 | A-18/E-5 | 60/40 |
| C-18 | A-29/E-21 | 50/50 |
| C-19 | A-31/E-22 | 65/35 |
| C-20 | A-3/A-6/E-14 | 20/45/35 |

A preferred mixing ratio between the curable resin containing two or more ethylenically unsaturated groups within the molecule and the curable resin containing the ring-opening polymerizable groups contained preferably in the curable composition for forming a hard coat layer may vary depending on the kind of the curable resin used and is not limited particularly. It is preferred that the ratio of the curable resin containing the ethylenically unsaturated groups is 30% by weight to 90% by weight and, more preferably, 50% by weight to 80% by weight based on the entire curable resin.

In a case of curing a curable composition containing the curable resin containing the ethylenically unsaturated groups and a curable resin containing the ring-opening polymerizable groups (“curable composition” is a composition containing both of the curable resins unless otherwise specified), it is preferred that the crosslinking reaction proceeds for both of the curable resins. A preferred crosslinking reaction for the ethylenically unsaturated groups is a radical polymerizable reaction, while a preferred crosslinking reaction for the ring-opening polymerizable groups is a cationic polymerizing reaction. In each of the cases, the polymerizing reaction can be proceeded by the effect of actinic energy rays. Usually, polymerization can be proceeded by adding a small amount of a radical generator and a cation generator (or acid generator) referred to as a polymerization initiator, decomposing the same by actinic energy rays thereby generating radicals and cations. The radical polymerization and the cation polymerization may be conducted separately but are preferably proceeded simultaneously.

In a case of curing the curable composition by the irradiation of actinic energy rays, the crosslinking reaction often proceeds preferably at a low temperature.

In the invention, radiation rays, γ-rays, α-rays, electron beams or UV-rays are used as the actinic energy rays. Among them, a method of using UV-rays, adding a polymerization initiator of generating radicals or cations and curing the same by UV-rays is particularly preferred. The curing can sometimes be proceeded further by heating after irradiation of UV-rays and the method can be used preferably. A preferred heating temperature in this case is 140° C. or lower.

The optical acid generator for generating cations by irradiation of UV-rays includes ionic curable resins such as triaryl sulfonium salts or diaryl iodonium salts and nonionic curable resins such as nitrobenzyl ester of sulfonic acid, for which various optical acid generators such as curable resins as described, for example, in “Organic Material for Imaging”, edited by Organic Electronics Material Study Group, published from Bunshin Publication Co. (1997) can be used. Among them, particularly preferred are sulfonium salts or iodonium salts and PF₆⁻, SbF₆⁻, AsFe⁻, and B (C₆F₅)₄⁻ are preferred as counter ions.

As examples of the polymerization initiator for generating radicals by UV-rays, known radical generators such as acetophenones, benzophenonens, Michler's ketone, benzoyl benzoate, benzoins, α-acyloxime ester, tetramethyl thiuram monosulfide and thioxantone can be used. Further, since the sulfonium salt and the iodonium salt usually used as the optical acid generators act as radical generators by the irradiation of UV-rays, they may be also used alone in the invention. Further, a sensitizer may also be used in addition to the polymerization initiator with an aim of improving the sensitivity. Examples of the sensitizer include n-buitylamine, triethylamine, tri-n-butylphosphifine, and thioxantone derivatives.

The polymerization initiators may be used in combination or one of them can be used alone, for example, in a case of a curable resin that generates both radicals and cations alone. As the addition amount of the polymerization initiator, it is used preferably within a range from 0.1 to 15% by weight and, more preferably, within a range from 1 to 10% by weight based on the total weight of the ethylenically unsaturated group-containing curable resin and the ring-opening polymerizable group-containing curable resin contained in the curable composition.

In a case of using the crosslinkable polymer having the repeating unit represented by formula (1) or the crosslinkable polymer having the repeating unit represented by formula (3) in the invention (hereinafter they are collectively referred to as “polymer of the invention”), since the polymer of the invention is generally solid or highly viscous liquid, it is difficult to be coated alone. In a case where the polymer is water soluble or in an aqueous dispersion, it can be coated in an aqueous system but it is usually dissolved in an organic solvent and coated. For the organic solvent, those capable of dissolving the polymer of the invention can be used without any particular restriction.

Preferred organic solvents include, for example, ketones such as methyl ethyl ketone, alcohols such as isopropanol and esters such as ethyl acetate. Further, in a case where the curable resin having mono-functional or poly-functional vinyl monomers or mono-functional, di-functional, tri- or higher functional ring-opening polymerizable group is a low molecular weight curable resin, the viscosity of the curable composition can be controlled by using them together and it can be coated without using the solvent.

Further, in the invention, fine particles may be added in the curable composition. Since the curing shrinkage in the hard coat layer can be decreased by the addition of the fine particles, close adhesion with a support can be improved or curling can be decreased, which is preferred. As the fine particles, any of fine inorganic particles, fine organic particles and organic-inorganic composite fine particles can be used. The fine inorganic particles include, for example, silicon dioxide particles, titanium dioxide particles, zirconium oxide particles, and aluminum oxide particles. Such fine inorganic particles are generally hard and when they are filled in the hard coat layer, not only the shrinkage during curing can be improved, but also the hardness on the surface can be enhanced.

However, since the fine particles generally tend to increase the haze, the method of filling is controlled in view of the balance for each of required characteristics.

Generally, since fine inorganic particles have low affinity with an organic ingredient such as the polymer of the invention and a polyfunctional vinyl monomer, mere mixing of them sometimes form aggregates or tends to cause cracking of the hard coat layer after curing. In the invention, in order to increase the affinity between the fine inorganic particles and the organic ingredient, the surface of the fine inorganic particles can be treated with a surface modifier containing an organic segment. The surface modifier preferably has a functional group capable of forming a bond with the fine inorganic particles or adsorbing to the fine inorganic particles and a functional group having high affinity with the organic ingredient in one identical molecule.

As the modifier having a functional group capable of bonding or adsorbing to the fine inorganic particles, a surface modifier of an alkoxide of metal as silane, aluminum, titanium or zirconium and a surface modifier having an anionic group such as phosphate group, sulfate group, sulfonate group or carboxylate group are preferred.

Further, as the functional group having high affinity with an organic ingredient, those having hydrophilic or hydrophobic property being adjusted with the organic ingredient may be adopted, However, a functional group capable of chemically bonding with the organic ingredient is preferred, and an ethylenically unsaturated group or a ring-opening polymerizable group is particularly preferred.

In the invention, a preferred surface modifier for the fine inorganic particles is a curable resin having a metal alkoxide or an anionic group and an ethylenically unsaturated group or a ring-opening polymerizable group with the molecule.

Typical examples of the surface modifiers can include an unsaturated double bond-containing coupling agent, an organic phosphate-containing organic curable resin, an organic sulfate-containing organic curable resin and an organic carboxylate-containing curable resin.
S-1 H₂C═C (X) COOC₃H₆Si (OCH₃)₃,
S-2 H₂C═C (X) COOC₂H₄OTi (OC₂H₅)₃,
S-3 H₂C═C (X) COOC₂H₄OCOC₅H₁₀OPO (OH)₂,
S-4 (H₂C═C (X) COOC₂H₄OCOC₅H₁₀O)₂POOH,
S-5 H₂C═C (X) COOC₂H4OSO₃H,
S-6 H₂C═C (X) COO (C₅H₁₀COO)₂H,
S-7 H₂C═C (X) COOC₅H₁₀COOH,
S-8 3-(glycidyloxy)propyltrimethoxysilane,
   in which here X represents a hydrogen atom or CH₃.

The surface modification of the fine inorganic particles is conducted preferably in a solution. A method of using the surface modifier together when the fine inorganic particles are mechanically dispersed finely, or adding and stirring the surface modifier after finely dispersing the fine inorganic particles, or conducting surface modification before finely dispersing the fine inorganic particles (optionally conducting warming, heating after drying or pH change), and then conducting fine dispersion may also be used.

As a solution for dissolving the surface modifier, an organic solvent having a large polarity is preferred. Specific examples include known solvents such as alcohol, ketone and ester.

Although there is no particular restriction for the fine organic particles, polymer particles comprising monomers having an ethylenically unsaturated group, for example, polymethyl methacrylate, polyethyl methacrylate, polyethyl acrylate, polybutyl acrylate, polyethylene, polypropylene and polystyrene, and polymer particles comprising a repeating unit represented by formula (1) or (3) in the invention are used preferably. In addition, they include resin particles such as polysiloxane, melamine resin, benzoguanamine resin, polytetrafluoroethylene, polycarbonate, nylon, polyvinyl alcohol, polytetrafluoroethylene, polyethylene terephthalate, polyvinyl chloride, acetyl cellulose, nitrocellulose, and gelatin. It is preferred that those particles are crosslinked.

As a pulverizing dispersion machines for the fine particles, it is preferred to use, for example, supersonic waves, disper, homogenizer, dissolver, polytron, paint shaker, sand grinder, kneader, eiger mill, DYNO mill, cobol mill, etc.

The amount of the fine particles to be filled is preferably from 2 to 40% by weight, more preferably, from 3 to 25% by weight and, most preferably, from 5 to 15% by weight based on the volume of the hard coat layer after filling.

The haze of the hard coat layer of the invention is, preferably, 7% or less, more preferably, 5% or less and, most preferably, 3% or less. In the haze evaluation method, a value measured automatically as: haze=(diffusion light/total transmission light)×100 (%) by using a turbidity meter “NDH-1001DP” manufactured by Nippon Denshoku Industry Co. was used.

In the hard coat film of the invention, the value expressing the curl according to the following numerical expression B is preferably within a range from −15 to +15 and, more preferably, within a range from −10 to +12 and, further preferably, from −10 to +10. In this case, the direction of measuring the curl within the specimen is along the transportation direction of the support in a case of coating in a web form.
Curl=1/R Numerical expression B:
(in which R represents the radius of curvature (m))

This is an important property so as not to cause cracking or film peeling in the production, fabrication and handling in the market of hard coat films. It is preferred that the curl value is within the range described above and the curl is small. Decreasing the curl to the range described above and increasing the surface hardness can be attained by controlling the volume shrinkage of the curable composition for forming the hard coat layer before and after curing to 15% or less.

The curl is measured by using a curl measuring form plate in the method A specified by “curl measuring method for photographic film” according to JIS K 7619-1988. The measuring conditions are at 25° C., 60% relative humidity, and moisture control time for 10 hours.

Plus for the curl means a curl where the coated side of the hard coat layer is at the inside of the curve, while minus means a curl where the coated side is at the outside of the curve.

Further, in the hard coat film of the invention, the absolute value for the difference for each of the curl values when only the relative humidity is changed to 80% and 10% based on the curl measuring method described above is preferably from 24 to 0, more preferably, from 15 to 0 and, most preferably, from 8 to 0. This is a property concerned with the handlability, peeling and cracking when films are adhered under various humidity.

For the cracking resistance of the hard coat film in the invention, the diameter of curvature causing cracking when curved with the coated side of the hard coat layer being at the outside is, preferably, 50 mm or less and, more preferably, 40 mm or less and, most preferably, 30 mm or less. For the cracking in the edge portion, it is preferred that cracking is not present or the length of cracking is less than 1 mm in average. The cracking resistance is an important property of not causing cracking defect during handling such as coating, fabrication, cutting and adhering of the hard coat film.

The support to be used for the hard coat film of the invention is preferably a transparent film, sheet or planar plastic. Specifically, a film or sheet for example of polyester such as polyethylene terephthalate and polyethylene naththalate, a cellulose resin such as triacetyl cellulose and diacetyl cellulose, polycarbonate, polymethyl methacrylate, polycarbonate, polysulfone, polyether sulfone polyallylate, cycloolefinic polymer is preferred. The thickness of the film is, preferably, from 20 to 300 μm, more preferably, from 80 to 200 μm. In a case where the thickness of the substrate is too thin, the strength of the film becomes weak and, on the other hand, in a case where the thickness is larger, the rigidity becomes excessively large. The thickness of the sheet may be within such a range as not deteriorating the transparency and those having 300 μm or more to several millimeters can be used.

An active energy ray curable coating liquid (coating solution of a curable composition) is prepared by dissolving mainly the polyfunctional monomer described above and a polymerization initiator to an organic solvent such as ketone, alcohol or ester. Further, a liquid dispersion of hard surface-modified fine inorganic particles and liquid dispersion of soft fine particles may be added for preparation.

The hard coat layer of the invention can be prepared by coating, on a substrate, an active energy ray curable coating solution by a known thin-film forming method such as a dipping method, spinner method, spray method, roll coating method, gravure method, wire bar method, slot extrusion coating method (single or multi-layer) or slide coating method, drying the coated material, and irradiating active energy rays for hardening.

The drying is conducted under the condition that the concentration of the organic solvent in the coated liquid membrane is, preferably, 5% or less by weight, more preferably, 2% or less by weight and, further preferably, 1% or less by weight after drying. The drying condition undergoes effects of thermal strength, transporting speed for the substrate, and the length of the drying step. Lower content of the organic solvent is preferred for increasing the polymerization rate.

Further, with an aim of improving the close adhesion of the substrate and the hard coat layer, a surface treatment can optionally be applied on one or both of surfaces of the substrate by an oxidizing method or roughening method. Examples of the oxidizing method can include corona discharge method, glow discharge method, chromic acid-treatment (wet type), flaming method, hot blow treatment and ozone/UV-ray irradiation treatment.

Further, one or more undercoat layers can be provided. Materials of the undercoat layer include, for example, copolymers or latexes of vinyl chloride, vinylidene chloride, butadiene, (meth)acrylate or vinyl ester, ester or low molecular weight polyester, water soluble polymers such as gelatin. Further, the undercoat layer can be incorporated with an antioxidant, for example, as metal oxides such as tin oxide, a composite oxide of tin oxide/antimony oxide, a composite oxide of tin oxide/indium oxide, and quaternary ammonium salt.

The hard coat layer can be constituted in the plurality of layers, or can be manufactured by properly superposing the layers in the order of the hardness

The light-transmitting layer of the invention is preferably adhered by way of a pressure sensitive adhesive layer with a substrate containing a support or a recording layer. In the step of providing the pressure sensitive adhesive layer, the pressure sensitive adhesive layer can be formed continuously to the light-transmitting film having a hard coat layer previously formed on one surface different from the hard coat layer coating surface. The method of providing the pressure sensitive adhesive layer is generally classified into a method of adhering a previously formed pressure sensitive adhesive layer (hereinafter sometimes referred to as an indirect method) and a method of directly coating and drying the pressure sensitive adhesive on the surface of the light-transmitting film thereby forming the pressure sensitive adhesive layer (hereinafter sometime referred to as a direct method).

“Method of a previously formed pressure sensitive adhesive layer” in the case of the indirect method shows a method of, for example, coating a pressure sensitive adhesive continuously to the surface of a releasable film of a size identical with the light-transmitting film, drying the adhesive thereby providing a pressure sensitive adhesive layer over the entire region of one surface of the releasable film and adhering the pressure sensitive adhesive layer to the light-transmitting film. As a result, a pressure sensitive adhesive layer with a releasable film is provided to the entire region on the other surface of the light-transmitting film.

The direct method is a method of delivering the top end of a light-transmitting film wound into a roll shape as far as a predetermined coating region, continuously coating a pressure sensitive adhesive from the top end to the final end on one surface of the light-transmitting film thereby forming a coating film and then drying the coating film successively thereby providing a pressure sensitive adhesive layer over the entire region on the other surface of the light-transmitting film.

In the direct and indirect methods, known coating means can be used as the coating means for the pressure sensitive adhesive. Specifically, they include, for example, spraying, roll coating, blade coating, doctor roll coating, and screen printing.

Further, as drying means, known means such as heat drying and blow drying can be used.

As the pressure sensitive adhesive, while acrylic, rubber or silicon adhesives can be used, pressure sensitive acrylic adhesive is preferred in view of transparency and durability. As such acrylic pressure sensitive adhesive, it is preferred to use those containing 2-ethylhexyl acrylate or n-butyl acrylate as the main ingredient and copolymerized, for example, with a short chained alkyl acrylate or methacrylate such as methyl acrylate, ethyl acrylate or methyl methacrylate for improving the cohesion, and acrylic acid, methacrylic acid, acrylamide derivative, maleic acid, hydroxyethyl acrylate or glycidyl acrylate which can be a crosslinkable point with a crosslinker. The glass transition temperature (Tg) and the crosslinking density can be varied by property controlling the mixing ratio and the kind of the main ingredient, the ingredient of short chains and the ingredient for the addition of crosslinking points.

Examples of the crosslinker to be used with the adhesive in combination include isocyanate crosslinkers, epoxy resin crosslinkers, melamine resin-based crosslinkers, urea resin crosslinkers and chelate crosslinkers and, among them, isocyanate crosslinkers are preferred. As such isocyanate crosslinker, isocyanates such as tolylene diisocyanate, 4-4′-diphenylmethane diisocyanate, hexamethylene diisocyanate, xylylene diisocyanate, naphthylene-1,5-diisocanate, o-toluidine isocyanate, isophorone diisocyanate, and triphenylmethane triisocyanate, reaction products of those isocyanates and polyalcohols, or polyisocyanates produced by condensation of isocyanates can be used. Examples of the commercially available products of those isocyanates can include, for example, Coronate L, Coronate HL, Coronate 2030, Coronate 2031, Mirionate MR, Mirionate HTL, manufactured by Nippon Polyurethane Industry Co. Ltd.; Takenate D-102, Takenate D-110N, Takenate D-200, Takenate D-202 manufactured by Takeda Pharmaceutical Co. Ltd.; and Desmodule L, Desmodule IL, Desmodule N, and Desmodule HL manufactured by Sumitomo Bayer Co. Ltd.

The pressure sensitive adhesive layer is formed to the light-transmitting film on the surface other than the surface where the hard coat layer is provided and a releasable film is preferably adhered to the surface of the pressure sensitive adhesive layer so as to prevent close adhesion between the hard coat layer and the pressure sensitive adhesive layer when the film is wound into a roll shape in the subsequent step. As described above, in the indirect method, the releasable film can be in a previously adhered state. On the other hand, in the direct method, it is preferred to add a step of adhering the releasable film to the surface of the pressure sensitive adhesive layer after forming the pressure sensitive adhesive layer to the surface of the light-transmitting film. The releasable film adhered to the surface of the pressure sensitive adhesive layer includes polyethylene film, polyethyelene terephthalate film, polyethylene naphthalate film, polycarbonate film, and triacetate cellulose film.

The thickness of the light-transmitting layer of the recording media according to the invention is preferably less than the thickness of the support. In view of the aberration that increases when the recording media is tilted, the thickness is, preferably, from 50 to 300 μm, more preferably, 60 to 200 μm and, further preferably, 70 to 120 μm. Further, variation of the thickness in one surface is ±3 μm at the greatest and, preferably, ±2 μm or less. It is, further preferably, ±1 μm or less.

The optical recording media of the invention conducts recording and reproduction of information, for example, as described below. At first, while rotating the optical recording media at a predetermined linear velocity (0.5 to 10 m/sec), or at a predetermined constant angular velocity, a recording light such as a bluish violet laser light, for example, at a wavelength of 405 nm by way of a objective lens from the side of the light-transmitting layer. Upon the irradiation of the light, the recording layer absorbs light to locally increase the temperature and, for example, pits are generated to change the optical property thereof and record the information. The information recorded as described above can be reproduced by using a bluish violet laser as an optical means while rotating the optical recording media at a predetermined constant linear velocity and irradiating a laser light on the side of the light-transmitting layer and detecting the reflection light therefrom.

The laser light source having an oscillation wavelength at 500 nm or less as the optical means for recording and reproduction can include, for example, a bluish violet semiconductor laser at an oscillation wavelength within a range from 390 to 415 nm, and a bluish violet laser SHG laser at a center oscillation wavelength of 425 nm.

Further, for increasing the recording density, NA of the objective lens used for the pick-up is, preferably, 0.7 or more and, more preferably, 0.85 or more.

### EXAMPLE

The invention is to be explained more specifically below, but the invention is not restricted to the following examples.

Preparation of Optical Recording Media

A. Preparation of Substrate and Recording Layer

Ag is sputtered on a grooved surface of an extrusion molded polycarbonate resin having spiral grooves (100 nm depth, 120 nm width and 320 nm track pitch) and 1.1 mm thickness, 120 mm diameter (polycarbonate; trade name of Panrite AD 5503, manufactured by Teijin Chemical) to form a light reflection layer of 100 nm thickness.

Then, 20 g of Orasol blue GN (recording material 1: phthalocyanine dye, manufactured by Ciba Speciality Chemical Co.) was added to 1 liter of 2,2,3,3-tetrafluoropropanol, supersonic treatment was applied for 2 hours to dissolve them to prepare a recording layer-forming coating solution. The prepared coating solution was coated on the light reflection layer under the condition of 23° C. and 50% RH while varying the number of rotations from 300 to 4000 rpm. The recording layer formed after storage at 23° C. and 50% RH for 1 to 4 hours had 100 nm thickness. ZnS—SiO₂ was sputtered on the recording layer so that the thickness was 5 nm to form an intermediate layer (barrier layer).

Further, as another example of the recording material, a laminate film comprising AgPdCu/ZnSSiO/AgInSeTe/ZnSSiO (recording material 2) was formed by film deposition as a phase change recording layer by using a DC and RF sputtering method, instead of Orasol Blue GN. Respective use of the recording materials 1 and 2 is described in Table 4.

B. Preparation of Light-Transmitting Layer (Hard Coat Film)

A light-transmitting layer (hard coat film) provided on the recording layer comprises a pressure sensitive adhesive layer, a light-transmitting film, a hard coat layer and, optionally, a stainproofing layer thereon in this order from the side of the substrate. In this case, an example of the preparation of a light-transmitting layer comprising a pressure sensitive adhesive layer, a light-transmitting film, a hard coat layer and, optionally, a stainproofing layer is shown, and a method for the preparation of the light-transmitting film (cellulose acylate film or cyclopolyolefin film), coating of the hard coat layer and coating of the stainproofing layer are to be explained in this order below.

1-1. Preparation of Cellulose Acylate Film (TAC-1)

A dihydroxyl terminated polyester having an average molecular weight of less than 2125 comprising adipic acid and ethylene glycol having repeating units of —[O—(CH₂)₂—OCO—(CH₂)₄CO]— and tolylene diisocyanate (TDI) were treated to synthesize a methylene chloride soluble polyester-urethane resin having an average molecular weight of 7300. The compound is referred to as PU-1. To the PU-1, cellulose acetate was added to obtain a dope of the following composition described below.

| | | |
|---|---|---|
| Cellulose triacetate | 100 | parts by weight |

(Substitution degree: 2.85, substitution degree at 6-position: 0.90)

| | | |
|---|---|---|
| PU-1 | 15 | parts by weight |
| Methylene chloride | 270 | parts by weight |
| Butanol | 7 | parts by weight |
| Methanol | 70 | parts by weight |

The composition was charged in a tightly sealed vessel and stirred under pressure while keeping the temperature at 80° C. and dissolved completely. Then, the dope was filtered, cooled and cast while being kept at 25° C. on a rotating drum of 30 cm diameter equipped with a jacket. The drum was comprised of an Sb material plated with a Ni layer of about 50 μm and further applied with twice hard chromium plating each of about 40 μm and the surface was subjected to super mirror polishing at 0.01 to 0.05 S. In this case, the surface temperature of the drum was kept at 0° C. by passing cold water through the jacket. The casting rate was set to 3 m/min, the film was peeled by way of a peeling roll at a position rotated by 270° from the casting position to the casting direction, the base was taken up at a speed of 3.15 m/min and 5% casting was conducted in the casting direction. The peeled based was fixed on both sides, dried by a hot blow at 70° C. to obtain a film of 80 tm thickness. The moisture expansion coefficient determined by measuring the length of the film when changing the humidity was 70 ppm/% RH.

1-2. Preparation of Cellulose Acylate Film Containing Deterioration-Preventing Agent (TAC-2, 3, 4, 5, 6, 7)

TAC-2 (deterioration-preventing agent 1 added), TAC-3 (deterioration-preventing agent 2 added), TAC-4 (deterioration-preventing agent 3 added), TAC-5 (deterioration-preventing agent 4 added), TAC-6 (deterioration-preventing agent 5 added) each of 80 μm film thickness was prepared in the same manner as in 1-1 above except for doping the following deterioration-preventing agents 1 to 5 each by 1 part by weight to TAC-1. Each of the films had an moisture expansion coefficient of 60, 43, 30, 25, and 35 ppm/% RH.

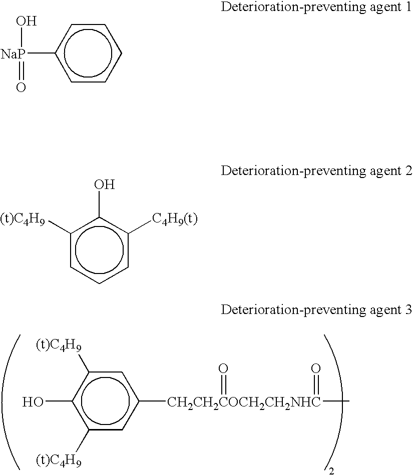

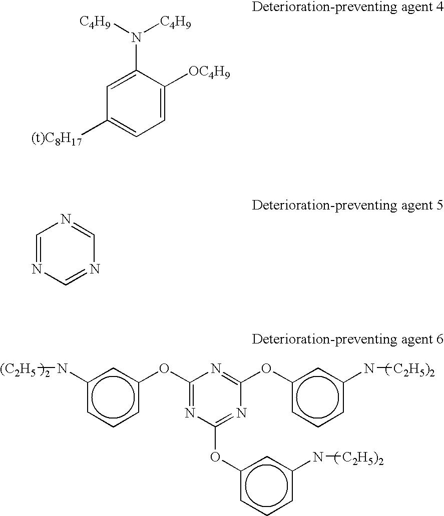

1-3. Preparation of Cellulose Acylate Film (TAC-8) Containing an Organic Chlorine-Containing Solvent in a Content of 10 ppm or Less

(Composition of dope for surface layer)

| Cellulose acetate | 100 | parts by weight |
|---|---|---|
| (substitution degree: 2.9, substitution degree at 6-position: 0.90) | | |
| Triphenyl phosphate | 13 | parts by weight |
| Tribenzylamine | 0.5 | parts by weight |
| Methylene chloride | 314 | parts by weight |
| Methanol | 44 | parts by weight |
| n-butanol | 12 | parts by weight |

(Composition of dope for core layer)

| Cellulose acetate | 100 | parts by weight |
|---|---|---|
| (substitution degree: 2.5, substitution degree at 6-position: 0.80) | | |
| Triphenyl phosphate | 10 | parts by weight |
| Diethylphthalate | 5 | parts by weight |
| Tribenzylamine | 0.5 | parts by weight |
| Acetone | 256 | parts by weight |
| Methanol | 110 | parts by weight |

Dope solutions each having the composition described above were prepared by a known method and, after filtration and cast on a support by co-casting on both frontal and rear surfaces of a core layer of 74 μm so that the outer layers (upper and lower surface layers) were each in 3 μm thickness as a dried film. In the co-casting, each dope was cast on a stainless steel substrate by using a feed-block type die under heating at 35° C. The cast product was dried at 80° C. for 3 min, peeled, and further dried at 120° C. for 10 min to obtain a dried film specimen. The content of the chlorine solvent as measured by gas chromatography was from 4 to 8 ppm. The moisture expansion coefficient of the film was 40 ppm/% RH.

1-4. Preparation of Cellulose Acylate Films (TAC-9, 10, 11) Containing Polyhydric Alcohol Ester of Aliphatic Polyhydric Alcohol and One or More Monocarboxylic Acids

Cellulose triacetate (linter, acetylation degree: 62.0%) 160 kg
Dipropylene glycol dibenzoate 40 kg
Methylene chloride 770 kg
Ethanol 65 kg

The materials described above were charged into a tightly sealed vessel, dissolved under stirring to prepare a dope solution. Then, the dope solution was uniformly cast on a stainless steel band substrate of 1500 mm width at 33° C. by using a belt casting apparatus. The temperature of the stainless steel band was controlled at 25° C. The solvent was evaporated till the amount of the residual solvent in the film caste on the stainless steel band substrate was decreased to 25%. Then, the film was peeled off from the stainless steel band at a peeling tension of 127 N/m. The peeled cellulose triacetate film was dried while being transported by numbers of rolls in a dry zone, to obtain a TAC-9 specimen of a cellulose triacylate film of 80 μm thickness.

TAC-10 was prepared in the same manner as described above except for replacing the polyhydric alcohol from dipropylene glycol dibenzoate to a compound 16. Further, TAC-11 was prepared in the same manner as TAC-10 except for adding each 0.8 g of TINUVIN 1.09, 171 and 326 (benzotriazole UV-ray absorbent manufactured by Chiba Specialty Chemicals Co. Ltd.). 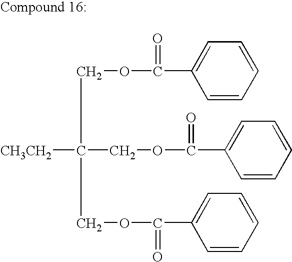
1-5. Preparation of Cyclopolyolefin Film (ZEO)

A cycloolefin resin prepared by hydrogenating a ring-opened copolymerizate of dicyclopentadiene-tetracyclododecene (glass transition temperature: 98° C., 5% heat loss temperature: 360° C.) was melted while heating in a kneader at 180° C. to obtain a molten resin. By using a 8 inch four inverted L-type calendering machine, the molten resin was passed successively through the gap between the rolls while setting the temperature of each roll at 190° C., finally peeled off from the rolls, and cooled to obtain a cyclopolyolefin film of 80 μm thickness. The moisture expansion coefficient of the film was 9 ppm/% RH.

2. Formation of Hard Coat Layer

2-1. Preparation of Coating Solution for Hard Coat Layer

(1) Preparation of H-1 Solution

Glycidyl methacrylate was dissolved in methyl ethyl ketone (MEK), reacted at 80° C. for 2 hours while dropping a heat polymerization initiator (V-65 manufactured by Wako Pure Chemical Industries Ltd.). The obtained reaction solution was dropped into hexane and precipitates were dried under a reduced pressure to obtain polyglycidyl methacrylate (molecular weight: 12,000, converted as polystyrene), which was dissolved in methyl ethyl ketone so as to obtain a 50 weight% concentration. To 100 parts by weight of the solution, were mixed under stirring 150 parts by weight of trimethylol propane triacrylate (VISCOAT #295; manufactured by Osaka Yuki Kagaku Kogyo Co.), 6 parts by weight of optical radical polymerization initiator (ILLUGACURE 184, manufactured by Ciba Geigy Co.), 6 parts by weight of an optical cation polymerization initiator (LOADSIL 2074, manufactured by Loadia Co.) and 10 parts by weight of MEGAFAX 531A (manufactured by Dainippon Ink and Chemicals Inc.) dissolved in 30 parts by weight of methyl isobutyl ketone, to prepare a coating solution (H-1) for a hard coat layer.

(2) Preparation of H-2 Solution

A coating solution (H-2) for a hard coat layer was prepared in the same manner as in the preparation for the coating solution (H-1) for the hard coat layer, except for changing MEGAFAX 531A with an equivalent weight of X-22-164B (manufactured by Shinetsu Chemical Co.).

(3) Preparation of H-3 Solution

To 93 parts by weight of dipentaerythritol hexaacrylate (DPHA, manufactured by Daicel UCB Co.), were mixed 5 parts by weight of R-3833 (manufactured by Daikin Fine Chemical Institute), 2 parts by weight of X-22-164C (manufactured by Shinetsu Chemical Co.), 3 parts by weight of an optical radical polymerization initiator (ILLUGACURE 907, manufactured by Ciba Geigy Co.) dissolved in a liquid mixture of methyl ethyl ketone/methyl isobutyl ketone (1:1 weight ratio), to prepare a coating solution (H-3) for a hard coat layer.

(4) Preparation of H-4 Solution

A coating solution (H-4) for a hard coat layer was prepared in the same manner as in the preparation of the coating solution (H-1) for the hard coat layer except for not adding MEGAFAX 531A.

(5) Preparation of H-5 Solution

A coating solution (H-5) for a hard coat layer was prepared in the same manner as in the preparation of the coating solution (H-1) for the hard coat layer, except for changing MEGAFAX 531A to an equal weight of a heat crosslinkable fluorine-containing polymer (JN-7214, manufactured by JSR Co.).

(6) Preparation of H-6 Solution

A coating solution (H-6) for a hard coat layer was prepared in the same manner as in the preparation of the coating solution (H-3) for the hard coat layer except for not adding R-3833.

(7) Preparation of a Coating Solution for Stainproofing Layer (a-1)

Isopropyl alcohol was added to a heat crosslinkable fluorine-containing polymer (JN-7214, manufactured by JSR Co.) to prepare a coarse liquid dispersion of 0.2% by weight. The coarse liquid dispersion was further dispersed supersonically to prepare an stainproofing coating solution.

2-2. Preparation of Hard Coat Film (Coating of Hard Coat Layer)

(1) Preparation of Single Layer Hard Coat Film

Corona treatment was applied to both surfaces of a cellulose acylate film and a cyclopolyolefin film formed to 80 μm film thickness, a latex comprising a styrene-butadiene copolymer having a refractive index of 1.55 and a glass transition temperature of 37° C. (LX407C5, manufactured by Nippon Zeon Co. Ltd.) and a tin oxide/antimony oxide composite oxide (FS-10D, manufactured by Ishihara Sangyo Co.) were mixed at 5.5 weight ratio, which was coated to a dry film thickness of 200 nm to a surface to be formed with a hard coat layer, to form an undercoat layer with an anti-static layer, and then the coating solution for the hard coat layer described above was coated by an extrusion method and dried each to a thickness described in Table 4, UV-rays were irradiated (700 mJ/cm²) and hard coat films each of the thickness described in Table 4 were prepared and taken up each into a roll shape.

Further, a polycarbonate film (PC) was used as a light-transmitting film and a hard coat layer was formed as described below on the film. A rolled polycarbonate film (Teijin Pure Ace: 75 μm thickness, having a releasing film on one side, with moisture expansion coefficient of 12 ppm/% RH) was used and sent to a predetermined coating region. After removing a previously provided releasable film, the hard coat solution was coated to form a coating layer, radiation rays were irradiated continuously to the coating layer thereby curing the radiation ray curable resin (UV-ray curable resin) to form a hard coat layer.

(2) Formation of Hard Coat Film With Stainproofing Layer

For a hard coat film used for an optical recording media 25 shown in Table 4, after coating the hard coat layer (H-4), a coating solution for stainproofing layer (a-1) was coated by using a wire bar to a dry film thickness of 0.1 μm, dried and then heat cured to form an stainproofing layer thereby obtaining a hard coat film with stainproofing layer.

C. Adhesion of Hard Coat Film and Substrate

An optical recording media was prepared as described below by adhering the hard coat film prepared in B above by way of a recording layer provided on the support described in A above.

1. Formation of Pressure Sensitive Adhesive Layer

An acrylic copolymer (solvent: ethyl acetate/toluene=1/1) and an isocyanate crosslinker (solvent: ethyl acetate/toluene=1/1) were mixed at 100:1 (weight ratio) to prepare a pressure sensitive adhesive coating solution A. Using the pressure sensitive adhesive coating solution A, a pressure sensitive adhesive layer is provided by an indirect method to the surface of a releasable film.

While transporting a polyethylene releasable film wound into a roll, the pressure sensitive adhesive coating solution A was coated to a dry thickness of 20 μm to the surface of the releasable film. Subsequently, it was dried at 100° C. in a drying region to obtain a releasable film provided with the pressure sensitive adhesive tape.

2. Preparation of a Transparent Sheet for Optical Recording Media

The releasable film provided with the pressure sensitive adhesive layer was adhered to the hard coat film on the surface opposite to the surface provided with the hard coat layer such that the pressure sensitive adhesive layer was in contact with the film. Then, the hard coat film provided with the hard coat layer and the pressure sensitive adhesive layer was again wound into a roll shape and kept in this state in an atmosphere of 23° C. 50% RH.

Then, the hard coat film provided with the hard coat layer and the pressure sensitive adhesive layer was rolling out and punched out into the same shape as the substrate. Thus, a transparent sheet for an optical recording media having the pressure sensitive adhesive layer on one surface and the hard coat layer on the other surface of the light-transmitting film was obtained.

3. Preparation of Optical Recording Media (Adhesion of Hard Coat Film to Support and Recording Layer)

A releasable film on the side of the pressure sensitive adhesive tape was peeled from the transparent sheet for the disk-like optical recording media and an intermediate layer and the pressure sensitive adhesive layer were adhered to each other by a roller pressing means to prepare an optical recording media.

D. Preparation of a Light-Transmitting Layer by Spin Coating

An optical recording media was prepared with a light-transmitting layer being prepared by the method described below instead of the light-transmitting layer by B and C described above as a comparative example.

After sputtering ZnS—SiO₃ on the recording layer to form a light-transmitting layer of 90 nm thickness, a UV-curable resin (SD-661, Trade name of products manufactured by Dainippon Ink and Chemicals Inc.) was coated on the light-transmitting layer by spin coating while changing the number of rotation from 100 rpm to 300 rpm, and UV-rays were irradiated by UV-lamps from above to cure the resin coating to manufacture an optical recording media.

E. Measurement

1. Pencil Hardness Test

After controlling the moisture for the film of the light-transmitting layer for the recording media under the conditions at a temperature of 25° C. and relative humidity of 60% for 2 hours, the pencil hardness at which no flaws were observed under a load of 9.8 N was determined by using a test pencil according to JIS-S-6006, in accordance with the pencil hardness evaluation method according to JIS-K-5400.

2. Scratch Resistance

Evaluation for the visible extent of scratches when rubbing the surface of the recording media on the side of the light-transmitting layer under a load of 1.96 N/cm² by using #0000 steel wool (“A” state in which traces are not visible after rubbing for 300 cycles, “B” state in which traces are slightly visible, “C” state in which traces are not visible till 100 cycles although traces remain, and “D” state in which traces are visible within 100 cycles).

3. Stainproof Property

Evaluation for the state after wiping off rapidly drying oil ink (“MAKKY” (registered trademark), manufactured by Zebra Co.) written on the surface of the recording media on the side of the light-transmitting layer for several times by using “TRACY” (registered trademark), manufactured by Toray Co. (“A” a state in which written traces are completely wiped off, “B” state in which traces are almost wiped off but remain slightly, “C” a state in which written traces are partially left without wiping off, and “D” state in which most of traces were left without wiped off.

4. Measurement for Recording Characteristics

The recording medias described above were mounted to a recording/reproducing apparatus having a bluish violet laser emitting a light at λ=405 nm and a pick-up constituted with an objective lens having a number of aperture NA of 0.7, and D8-14 modified signals set to the shortest pit length of 0.24 μm were recorded and reproduced to measure signal reproduction jitter. Smaller jitter is more preferred and, specifically, it is preferably 5% or less. For the jitter increase in Table 4, the signal reproduction jitter was measured in the same manner of the storing under the conditions at 80° C., 80% RH for seven days, and the jitter increase was shown by the difference between the hitter values before and after the storage.

The thus prepared optical recording media and the results of various measurements therefor are shown in Table 4.

TABLE 4

| | Record- | Light-transmitting layer | | | | | | | | | | | |
|---|---|---|---|---|---|---|---|---|---|---|---|---|---|
| | ing | Ad- | | | Moisture | Hard | Hard | Stain- | | | | | |
| Optical | layer | hesive | | | expansion | coat | coat | proofing | | | | | |
| record- | Record- | thick- | | Film | coeffi- | layer | layer | layer | Pencil | Scratch | Stain- | | |
| ing | ing | ness | | thickness | cient | formu- | thickness | thickness | hard- | resis- | proof | Jitter | |
| media | material | (μm) | Film | (μm) | (ppm/% RH) | lation | (μm) | (μm) | ness | tance | property | increment | Remark |
| 1 | 1 | spin coat | | | | | | | 5B | D | D | 6% | Comp. |
| | | | | | | | | | | | | | Example |
| 2 | 1 | 20 | PC | 80 | 12 | — | 0 | 0 | 4B | D | D | 8% | Comp. |
| | | | | | | | | | | | | | Example |
| 3 | 1 | 14 | PC | 80 | 12 | H-1 | 6 | 0 | 2H | B | B | 5% | Invention |
| 4 | 1 | 20 | TAC-1 | 80 | 70 | — | 0 | 0 | H | C | C | 12% | Comp. |
| | | | | | | | | | | | | | Example |
| 5 | 1 | 14 | TAC-1 | 80 | 70 | H-1 | 6 | 0 | 3H | A | A | 7% | Comp. |
| | | | | | | | | | | | | | Example |
| 6 | 1 | 14 | TAC-2 | 80 | 60 | H-1 | 6 | 0 | 3H | A | A | 2% | Invention |
| 7 | 1 | 14 | TAC-3 | 80 | 43 | H-1 | 6 | 0 | 3H | A | A | 1% | Invention |
| 8 | 1 | 14 | TAC-4 | 80 | 30 | H-1 | 6 | 0 | 3H | A | A | 2% | Invention |
| 9 | 1 | 14 | TAC-5 | 80 | 25 | H-1 | 6 | 0 | 3H | A | A | 2% | Invention |
| 10 | 1 | 14 | TAC-6 | 80 | 35 | H-1 | 6 | 0 | 3H | A | A | 3% | Invention |
| 11 | 1 | 14 | TAC-7 | 80 | 40 | H-1 | 6 | 0 | 3H | A | A | 3% | Invention |
| 12 | 2 | 20 | PC | 80 | 12 | — | 0 | 0 | 4B | D | D | 7% | Comp. |
| | | | | | | | | | | | | | Example |
| 13 | 2 | 14 | PC | 80 | 12 | H-1 | 6 | 0 | 2H | B | B | 4% | Invention |
| 14 | 2 | 14 | PC | 80 | 12 | H-6 | 6 | 0 | HB | C | B | 5% | Comp. |
| | | | | | | | | | | | | | Example |
| 15 | 2 | 20 | TAC-1 | 80 | 70 | — | 0 | 0 | H | C | C | 10% | Comp. |
| | | | | | | | | | | | | | Example |
| 16 | 2 | 14 | TAC-1 | 80 | 70 | H-1 | 6 | 0 | 3H | A | A | 6% | Comp. |
| | | | | | | | | | | | | | Example |
| 17 | 2 | 14 | TAC-2 | 80 | 60 | H-1 | 6 | 0 | 3H | A | A | 1% | Invention |
| 18 | 1 | 34 | TAC-2 | 60 | 60 | H-1 | 6 | 0 | 2H | B | A | 2% | Invention |
| 19 | 1 | 14 | TAC-2 | 60 | 70 | H-1 | 26 | 0 | 4H | A | A | 1% | Invention |
| 20 | 1 | 14 | TAC-1 | 60 | 60 | H-1 | 26 | 0 | 4H | A | A | 10% | Invention |
| 21 | 1 | 54 | TAC-2 | 40 | 60 | H-1 | 6 | 0 | 2H | B | A | 1% | Invention |
| 22 | 1 | 14 | TAC-2 | 80 | 60 | H-2 | 6 | 0 | 3H | A | A | 2% | Invention |
| 23 | 1 | 14 | TAC-2 | 80 | 60 | H-3 | 6 | 0 | 3H | A | A | 2% | Invention |
| 24 | 1 | 14 | TAC-2 | 80 | 60 | H-4 | 6 | 0 | 3H | A | C | 3% | Invention |
| 25 | 1 | 14 | TAC-2 | 80 | 60 | H-4 | 6 | 0.1 | 3H | A | B | 1% | Invention |
| 26 | 1 | 14 | TAC-2 | 80 | 60 | H-5 | 6 | 0 | 3H | A | A | 2% | Invention |
| 27 | 1 | 14 | TAC-2 | 80 | 60 | H-5 | 6 | 0 | H | C | A | 5% | Comp. |
| | | | | | | | | | | | | | Example |
| 28 | 1 | 10 | TAC-2 | 80 | 60 | H-1 | 10 | 0 | 3H | A | A | 2% | Invention |
| 29 | 1 | 5 | TAC-2 | 80 | 60 | H-1 | 15 | 0 | 4H | A | A | 2% | Invention |
| 30 | 1 | 17 | TAC-2 | 80 | 60 | H-1 | 3 | 0 | 2H | B | A | 5% | Invention |
| 31 | 1 | 19 | TAC-2 | 80 | 60 | H-1 | 1 | 0 | H | C | B | 3% | Comp. |
| | | | | | | | | | | | | | Example |
| 32 | 1 | 19 | TAC-1 | 80 | 70 | H-1 | 1 | 0 | H | C | B | 11% | Comp. |
| | | | | | | | | | | | | | Example |
| 33 | 1 | 20 | ZEO | 80 | 9 | — | 0 | 0 | HB | C | D | 5% | Comp. |
| | | | | | | | | | | | | | Example |
| 34 | 1 | 14 | ZEO | 80 | 9 | H-1 | 6 | 0 | 2H | B | A | 3% | Invention |
| 35 | 1 | 14 | ZEO | 80 | 9 | H-6 | 6 | 0 | H | C | A | 4% | Comp. |
| | | | | | | | | | | | | | Example |
| 36 | 1 | 14 | TAC-8 | 80 | 58 | H-1 | 6 | 0 | 3H | A | A | 1% | Invention |
| 37 | 1 | 14 | TAC-9 | 80 | 55 | H-1 | 6 | 0 | 3H | A | A | 2% | Invention |
| 38 | 1 | 14 | TAC-10 | 80 | 50 | H-1 | 6 | 0 | 3H | A | A | 3% | Invention |
| 39 | 1 | 14 | TAC-11 | 80 | 60 | H-1 | 6 | 0 | 3H | A | A | 2% | Invention |

In view of Table 4, the followings were found in the optical recording medias 6 to 15 formed by adhering hard coat films each provided with the hard coat layer of the invention to TAC-2 to TAC-11, not only the pencil hardness, the scratch resistance and the stainproof property were improved but also the jitter increment was decreased to improve the recording characteristics. In the optical recording media 5 formed by adhering the hard coat film provided with the hard coat layer of the invention to a usual cellulose acylate film (TAC-1), only the pencil hardness, scratch resistance and the stainproofing property were improved, whereas the recording characteristics were improved in the optical recording medias 6 to 11 of using the cellulose acylate film having an moisture expansion coefficient of 8 ppm/% RH to 62 ppm/% RH incorporated with an deterioration-preventing agent or decreased for the content of the organic chlorine solvent to 10 ppm or less, and this was an unexpected effect. Further, also the optical recording media formed by adhering the hard coat film provided with the hard coat layer of the invention to the cyclopolyolefin film and the polycarbonate film was improved with pencil hardness, scratch resistance and stainproofing property to attain desired performance.

This application is based on Japanese Patent Application Nos. JP2003-324185 and JP2003-389263, filed on Sep. 17, 2003 and Nov. 19, 2003, respectively, the contents of which is incorporated herein by reference.

### INDUSTRIAL APPLICABILITY

The invention is applicable to an optical recording system, particularly effective for an optical recording system utilizing a bluish violet laser and a high NA pick-up.

1. A recording media capable of reproducing an information signal by an optical means, which comprises: a support; a recording layer capable of recording the information signal; and a light-transmitting layer capable of transmitting a light in this order,
wherein the light-transmitting layer comprises a light-transmitting film having a moisture expansion coefficient of 8 ppm/% RH to 62 ppm/% RH; and the light-transmitting layer has a surface having a pencil hardness of 2 H or more.

2. The recording media according to claim 1, wherein the light-transmitting layer comprises a hard coat layer on the light-transmitting film,
wherein the hard coat layer comprises a cured film formed from a curable composition comprising; a first curable resin having a molecule, the molecule having two or more ethylenically unsaturated groups; and a second curable resin having a ring-opening polymerizable group.

3. The recording media according to claim 2, wherein the light-transmitting film is a cyclic polyolefin film.

4. The recording media according to claim 2, wherein the light-transmitting film is a polycarbonate film.

5. A recording media capable of reproducing an information signal by an optical means, which comprises: a support; a recording layer capable of recording the information signal; and a light-transmitting layer capable of transmitting a light in this order,
wherein the light-transmitting layer comprises a light-transmitting film comprising a cellulose acylate film, the cellulose acylate film comprising at least one deterioration-preventing agent selected from the group consisting of (A) a peroxide-decomposing agent, (B) a radical chain inhibitor, (C) a metal-inactivating agent and (D) an acid-captivating agent.

6. A recording media capable of reproducing an information signal by an optical means, which comprises: a support; a recording layer capable of recording the information signal; and a light-transmitting layer capable of transmitting a light in this order,
wherein the light-transmitting layer comprises a light-transmitting film comprising a cellulose acylate film, the cellulose acylate film having an organic chlorine-containing solvent of 10 ppm or less.

7. A recording media capable of reproducing an information signal by an optical means, which comprises: a support; a recording layer capable of recording the information signal; and a light-transmitting layer capable of transmitting a light in this order,
wherein the light-transmitting layer comprises a light-transmitting film comprising a cellulose acylate film, the cellulose acylate film comprising a polyhydric alcohol ester of an aliphatic polyhydric alcohol and a monocarboxylic acid.

8. The recording media according to claim 7, wherein the monocarboxylic acid has an aromatic ring or a cycloalkyl ring.

9. The recording media according to claim 7, wherein the aliphatic polyhydric alcohol is one of 2- to 20-valent alcohols.

10. The recording media according to claim 5, wherein the light-transmitting film has a moisture expansion coefficient of 8 ppm/% RH to 62 ppm/% RH.

11. The recording media according to claim 5, wherein the light-transmitting layer has a hard coat layer on the light-transmitting film; and the hard coat layer comprises a cured film formed from a curable composition, the curable composition comprising a curable resin capable of being cured upon an active energy ray.

12. The recording media according to claim 11, wherein the curable composition comprises a first curable resin having a molecule, the molecule having two or more ethylenically unsaturated groups; and a second curable resin having a ring-opening polymerizable group.

13. The recording media according to claim 1, wherein the light-transmitting layer has a thickness of 50 μm to 300 μm.

14. The recording media according to claim 8, wherein the aliphatic polyhydric alcohol is one of 2- to 20-valent alcohols.

15. The recording media according to claim 6, wherein the light-transmitting film has a moisture expansion coefficient of 8 ppm/% RH to 62 ppm/% RH.

16. The recording media according to claim 7, wherein the light-transmitting film has a moisture expansion coefficient of 8 ppm/% RH to 62 ppm/% RH.

17. The recording media according to claim 6, wherein the light-transmitting layer has a hard coat layer on the light-transmitting film; and the hard coat layer comprises a cured film formed from a curable composition, the curable composition comprising a curable resin capable of being cured upon an active energy ray.

18. The recording media according to claim 7, wherein the light-transmitting layer has a hard coat layer on the light-transmitting film; and the hard coat layer comprises a cured film formed from a curable composition, the curable composition comprising a curable resin capable of being cured upon an active energy ray.

19. The recording media according to claim 17, wherein the curable composition comprises a first curable resin having a molecule, the molecule having two or more ethylenically unsaturated groups; and a second curable resin having a ring-opening polymerizable group.

20. The recording media according to claim 18, wherein the curable composition comprises a first curable resin having a molecule, the molecule having two or more ethylenically unsaturated groups; and a second curable resin having a ring-opening polymerizable group.

21. The recording media according to claim 5, wherein the light-transmitting layer has a thickness of 50 μm to 300 μm.

22. The recording media according to claim 6, wherein the light-transmitting layer has a thickness of 50 μm to 300 μm.

23. The recording media according to claim 7, wherein the light-transmitting layer has a thickness of 50 μm to 300 μm.
